(19) United States
(12) Patent Application Publication
(10) Pub. No.: US 2018/0018322 A1
(43) Pub. Date: Jan. 18, 2018

(54) SYSTEM AND METHOD FOR AUTOMATICALLY UNDERSTANDING LINES OF COMPLIANCE FORMS THROUGH NATURAL LANGUAGE PATTERNS

(71) Applicant: Intuit Inc., Mountain View, CA (US)

(72) Inventors: Saikat Mukherjee, Fremont, CA (US); Karpaga Ganesh Patchirajan, Plano, TX (US)

(73) Assignee: Intuit Inc., Mountain View, CA (US)

(21) Appl. No.: 15/606,370

(22) Filed: May 26, 2017

Related U.S. Application Data
(63) Continuation-in-part of application No. 15/488,052, filed on Apr. 14, 2017.
Application No. 15/488,052 is a continuation-in-part of application No. 15/293,553, filed on Oct. 14, 2016.
Application No. 15/293,553 is a continuation-in-part of application No. 15/292,510, filed on Oct. 13, 2016.
(60) Provisional application No. 62/362,688, filed on Jul. 15, 2016.
(60) Provisional application No. 62/362,688, filed on Jul. 15, 2016.
(60) Provisional application No. 62/362,688, filed on Jul. 15, 2016.

(51) Int. Cl. G06F 17/27; G06Q 40/00; G06F 17/24; G06Q 10/10

(52) U.S. Cl. CPC G06F 17/2785; G06Q 10/10; G06Q 40/123; G06F 17/243

(57) ABSTRACT

A method and system parses natural language in a unique way, determining important words pertaining to a text corpus of a particular genre, such as tax preparation. Sentences extracted from instructions or forms pertaining to tax preparation, for example are parsed to determine word groups forming various parts of speech, and then are processed to exclude words on an exclusion list and word groups that don't meet predetermined criteria. From the resulting data, synonyms are replaced with a common functional operator and the resulting sentence text is analyzed against predetermined patterns to determine one or more functions to be used in a document preparation system.

### RELATED CASES

This application is a Continuation In Part application depending from a patent application filed Apr. 14, 2017 having attorney docket number INTU1710236, Ser. No. 15/488,052, and entitled METHOD AND SYSTEM FOR AUTOMATICALLY EXTRACTING RELEVANT TAX TERMS FROM FORMS AND INSTRUCTIONS naming inventors Saikati Mukherjee, et. al, which is a Continuation In Part application depending from a patent application filed Oct. 14, 2016 having attorney docket number INTU179968, Ser. No. 15/293,553, and entitled SYSTEM AND METHOD FOR AUTOMATIC LEARNING OF FUNCTIONS naming inventors Cem Unsal, et.al., which is a Continuation In Part depending from a patent application filed Oct. 13, 2016 having attorney docket number INTU179969, Ser. No. 15/292,510, and entitled SYSTEM AND METHOD FOR SELECTING DATA SAMPLE GROUPS FOR MACHINE LEARNING OF CONTEXT OF DATA FIELDS FOR VARIOUS DOCUMENT TYPES AND/OR FOR TEST DATA GENERATION FOR QUALITY ASSURANCE SYSTEMS naming inventor Cem Unsal. These applications depend from a provisional patent application filed Jul. 15, 2016 having attorney docket number INTU169813, Ser. No. 62/362,688, and entitled SYSTEM AND METHOD FOR MACHINE LEARNING OF CONTEXT OF LINE INSTRUCTIONS FOR VARIOUS DOCUMENT TYPES naming inventors Cem Unsal, et al. These referenced applications are hereby incorporated herein by reference in their entirety as if the contents were presented herein directly.

### BACKGROUND

Many people use electronic document preparation systems to help prepare important documents electronically. For example, each year millions of people use electronic document preparation systems customized for tax, i.e. electronic tax return preparation systems, to help prepare and file their tax returns. Typically, electronic tax return preparation systems receive tax related information from a user and then automatically populate the various fields in electronic versions of government tax forms. Electronic tax return preparation systems represent a potentially flexible, highly accessible, and affordable source of tax return preparation assistance for customers. However, processes that enable the electronic tax return preparation systems to determine underlying relations between the various fields and automatically determine and populate various data fields of the tax forms often utilize large amounts of computing system resources and human resources.

For instance, due to changes in tax laws, or due to updates in government tax rules, tax forms can change from year to year, or even multiple times in a same year. If a physical or electronic tax form required by a governmental entity is updated, or a new tax form is introduced, it is typically very difficult to efficiently update electronic tax return preparation systems to correctly determine tax data appropriate for and populate the various fields of the new or changed tax forms with required values. Tax forms are written by humans for human review, interpretation and understanding. A particular line of an updated tax form may have text describing a requirement of an input according to one or more functions that use line item values from other lines of the updated tax form and/or line item values from other tax related forms or worksheets. These functions range from very simple to very complex, and are often baffling to the humans the text of the various lines was written for, and are thus even much more burdensome when a computing system is introduced in the form of a tax preparation system that is configured to prepare and/or file electronic versions of the tax forms.

Updating an electronic tax return preparation system often includes utilizing a combination of tax experts to interpret the tax forms consistent with the intent of the humans who prepared the text of the tax forms, software and system engineers who consult with the tax experts to understand and develop the human expert view of individual tax forms, and large amounts of computing resources, to develop, code, and incorporate the new functions and forms into the electronic tax return preparation system.

Interaction that is required between the tax experts, software and system engineers can lead to significant software release delays and incur great expense in releasing an updated version of the electronic tax return preparation system. These delays and expenses are then passed on to customers of the electronic tax return preparation system who have deadlines to file tax returns associated with the new or updated forms. Furthermore, because humans are inherently error prone, already-existing processes for updating electronic tax returns can introduce significant inaccuracies into the functions and processes of the electronic tax return preparation system.

These expenses, delays, and inaccuracies can have an adverse impact on the implementation and use of traditional electronic tax return preparation systems. Customers may lose confidence in the electronic tax return preparation systems. Furthermore, customers may simply decide to utilize less expensive options for preparing their taxes. Further, vast amounts of computing resources are consumed determining inaccurate tax return data which is then provided to and processed by other entities, such as government entities, i.e. the Internal Revenue Service.

These issues and drawbacks are not limited to electronic tax return preparation systems. Any electronic document preparation system that assists users to electronically fill out forms or prepare documents suffer from these same inaccuracies and drawbacks when the physical forms relating to the electronic forms are created or updated. This a longstanding technical problem existing in many computing fields.

### SUMMARY

Embodiments of the present disclosure provide a technical solution to the longstanding problems discussed herein, and thus solve some of the shortcomings associated with traditional electronic document preparation systems by providing methods and systems for employing natural language processing to generate and update functions associated with a document preparation system, such as functions associated with a tax preparation system. In one embodiment, natural language programming is used to automatically analyze text in a unique and novel way to determine operators, operands, and dependencies associated with one or more lines of one or more tax forms, to use those operators, operands, and dependencies to generate one or more functions to be used by users of the tax preparation system to prepare their taxes.

By employing the processes and systems discussed herein, accuracy and efficiency of generated functions is significantly improved over prior art processes and systems. Further, the software release delays discussed above as being associated with prior art systems are significantly reduced and sometimes eliminated entirely. Expenses associated with releasing an updated version of the electronic tax return preparation system are also greatly reduced, as compared with prior art systems and processes.

Herein, token and word are interchangeable synonymous terms and the use of one may be replaced by the other.

In more particularity, embodiments include a computing system implemented method for learning and incorporating forms in an electronic document preparation system including receiving electronic textual data including instructions to determine one or more form field values of one or more forms of the plurality of forms. The method further includes, in one embodiment, analyzing the electronic textual data to determine sentence data representing separate sentences of the electronic textual data, and separating the electronic textual data into the determined separate sentences. Further, in one embodiment, for each sentence, extracting, for each given sentence of sentence data representing sentences in a data array, operand data representing one or more extracted operands of the sentence, and determining sentence fragment data for parts of speech for sentence fragments of the sentence including sentence fragment data representing word groups forming one or more parts of speech. Then, in one embodiment, separating sentence fragment data of the sentence containing verbs and sentence fragment data containing “if” or “minus” where the associated part of speech is either a prepositional phrase or a clause introduced by a subordinating conjunction, resulting in separated sentence fragment data.

Further, in one embodiment, for each token/word present in sentence data, removing any token/word present in exclusion data, filtering the sentence data to keep only tokens/words meeting at least one token test, and combining the filtered token data and the separated sentence fragment data and eliminating sentence fragments containing words from the exclusion data representing a predetermined exclusion list, resulting in filtered sentence fragment data. Finally, in one embodiment, replacing, within sentences of the data array, all single-word sentence fragments of the filtered sentence fragment data having similar meanings with a single word and extracting text-readable functions from sentences of the data array by matching predetermined patterns and replacing matched patterns with function data representing text-readable functions, converting the function data to computer readable functions, and implementing one or more of the computer readable functions in a document preparation system such as a tax preparation system.

In one embodiment, the computer readable functions associated with one or more form fields of a document associated with a document preparation system include one or more dependencies.

In one embodiment, dependencies for a given data field of the new and/or updated form includes references to data values from one or more other data fields of the new and/or updated form. In one embodiment, the dependencies for a given data field of the new and/or updated form includes references to data values from other data fields of one or more other old, new, or updated forms, worksheets, or data values from other locations internal or external to the electronic document preparation system. In one embodiment, the dependencies include one or more constants.

In addition to possibly including one or more dependencies, in one embodiment, a final function for a given data field of the new and/or updated form includes one or more operators that operate on one or more of the dependencies in a particular manner. The operators include, in various embodiments, arithmetic operators such as addition, subtraction, multiplication, division or other mathematical operators such as exponential functions and logical operators such as if-then, and, or, if-then-else operators, and/or Boolean operators such as true/false. The operators can include also existence condition operators that depend on the existence of a data value in another data field of new and/or updated form, in a form other than the new and/or updated form, or in some other location or data set. The operators can include string comparisons and/or rounding or truncating operations.

Embodiments of the present disclosure address some of the shortcomings associated with traditional electronic document preparation systems that do not adequately and efficiently automatically learn and incorporate new functions associated with new forms or with changes associated with updated forms. An electronic document preparation system in accordance with one or more embodiments provides efficient and reliable incorporation of new and/or updated forms by utilizing machine learning in conjunction with training set data in order to quickly and accurately incorporate and learn functions associated with those new and/or updated forms. The various embodiments of the disclosure can be implemented to improve the technical fields of data processing, resource management, data collection, and user experience. Therefore, the various described embodiments of the disclosure and their associated benefits amount to significantly more than an abstract idea. In particular, by utilizing machine learning to learn and incorporate new and/or updated forms in an electronic document preparation system, users can save money and time and can better manage their finances.

Using the disclosed embodiments of a method and system for learning and incorporating new and/or updated forms in an electronic document preparation system, a method and system for learning and incorporating new and/or updated forms in an electronic document preparation system significantly greater accurately is provided over traditional prior art systems. Therefore, the disclosed embodiments provide a technical solution to the long standing technical problem of efficiently learning and incorporating new and/or updated forms in an electronic document preparation system.

In addition, the disclosed embodiments of a method and system for learning and incorporating new and/or updated forms in an electronic document preparation system are also capable of dynamically adapting to constantly changing fields such as tax return preparation and other kinds of document preparation. Consequently, the disclosed embodiments of a method and system for learning and incorporating new and/or updated forms in an electronic document preparation system also provide a technical solution to the long standing technical problem of static and inflexible electronic document preparation systems.

The result is a much more accurate, adaptable, and robust method and system for learning and incorporating new and/or updated forms in an electronic document preparation system, but thereby serves to bolster confidence in electronic document preparation systems. This, in turn, results in: less human and processor resources being dedicated to analyzing new and/or updated forms because more accurate and efficient analysis methods can be implemented, i.e., fewer processing and memory storage assets; less memory and storage bandwidth being dedicated to buffering and storing data; less communication bandwidth being utilized to transmit data for analysis.

The disclosed method and system for learning and incorporating new and/or updated forms in an electronic document preparation system does not encompass, embody, or preclude other forms of innovation in the area of electronic document preparation systems. In addition, the disclosed method and system for learning and incorporating new and/or updated forms in an electronic document preparation system is not related to any fundamental economic practice, fundamental data processing practice, mental steps, or pen and paper based solutions, and is, in fact, directed to providing solutions to new and existing problems associated with electronic document preparation systems. Consequently, the disclosed method and system for learning and incorporating new and/or updated forms in an electronic document preparation system, does not encompass, and is not merely, an abstract idea or concept.

### BRIEF DESCRIPTION OF THE DRAWINGS

FIG. 1 is a block diagram of software architecture for learning and incorporating new and/or updated forms in an electronic document preparation system, in accordance with one embodiment.

FIG. 2 is a block diagram of a process for learning and incorporating new and/or updated forms in an electronic document preparation system, in accordance with one embodiment.

FIG. 3 is a flow diagram of a process for learning and incorporating new and/or updated forms in an electronic document preparation system, in accordance with one embodiment.

FIG. 4 is a flow diagram of a process for learning and incorporating new and/or updated forms in an electronic document preparation system, in accordance with one embodiment.

FIG. 5 is a flow diagram of a process for learning and incorporating new and/or updated forms in an electronic document preparation system, in accordance with one embodiment.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying figures, which depict one or more exemplary embodiments. Embodiments may be implemented in many different forms and should not be construed as limited to the embodiments set forth herein, shown in the figures, and/or described below. Rather, these exemplary embodiments are provided to allow a complete disclosure that conveys the principles of the invention, as set forth in the claims, to those of skill in the art.

Herein, the term “production environment” includes the various components, or assets, used to deploy, implement, access, and use, a given application as that application is intended to be used. In various embodiments, production environments include multiple assets that are combined, communicatively coupled, virtually and/or physically connected, and/or associated with one another, to provide the production environment implementing the application.

As specific illustrative examples, the assets making up a given production environment can include, but are not limited to, one or more computing environments used to implement the application in the production environment such as a data center, a cloud computing environment, a dedicated hosting environment, and/or one or more other computing environments in which one or more assets used by the application in the production environment are implemented; one or more computing systems or computing entities used to implement the application in the production environment; one or more virtual assets used to implement the application in the production environment; one or more supervisory or control systems, such as hypervisors, or other monitoring and management systems, used to monitor and control assets and/or components of the production environment; one or more communications channels for sending and receiving data used to implement the application in the production environment; one or more access control systems for limiting access to various components of the production environment, such as firewalls and gateways; one or more traffic and/or routing systems used to direct, control, and/or buffer, data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the application in the production environment; one or more databases used to store data in the production environment; one or more internal or external services used to implement the application in the production environment; one or more backend systems, such as backend servers or other hardware used to process data and implement the application in the production environment; one or more software systems used to implement the application in the production environment; and/or any other assets/components making up an actual production environment in which an application is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

In various embodiments, each computing environment includes allocated assets and virtual assets associated with, and controlled or used to create, and/or deploy, and/or operate an application.

In various embodiments, one or more cloud computing environments are used to create, and/or deploy, and/or operate an application that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given application or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through, a cloud computing environment; and/or any other virtualized assets and/or sub-systems of “bare metal” physical devices such as mobile devices, remote sensors, laptops, desktops, point-of-sale devices, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing, can be implemented as one or more virtual assets.

In one embodiment, two or more assets, such as computing systems and/or virtual assets, and/or two or more computing environments, are connected by one or more communications channels including but not limited to, Secure Sockets Layer communications channels and various other secure communications channels, and/or distributed computing system networks, such as, but not limited to: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein, the term “user” includes, but is not limited to, any party, parties, entity, and/or entities using, or otherwise interacting with any of the methods or systems discussed herein. For instance, in various embodiments, a user can be, but is not limited to, a person, a commercial entity, an application, a service, and/or a computing system. In one or more embodiments, there may be different parties noted that perform different levels of tasks, such as a user filling in a form supplied through an electronic document system managed, operated or otherwise controlled by a third party, such as a business entity.

As used herein, the term “relationship(s)” includes, but is not limited to, a logical, mathematical, statistical, or other association between one set or group of information, data, and/or users and another set or group of information, data, and/or users, according to one embodiment. The logical, mathematical, statistical, or other association (i.e., relationship) between the sets or groups can have various ratios or correlation, such as, but not limited to, one-to-one, multiple-to-one, one-to-multiple, multiple-to-multiple, and the like, according to one embodiment. As a non-limiting example, if the disclosed electronic document preparation system determines a relationship between a first group of data and a second group of data, then a characteristic or subset of a first group of data can be related to, associated with, and/or correspond to one or more characteristics or subsets of the second group of data, or vice-versa, according to one embodiment. Therefore, relationships may represent one or more subsets of the second group of data that are associated with one or more subsets of the first group of data, according to one embodiment. In one embodiment, the relationship between two sets or groups of data includes, but is not limited to similarities, differences, and correlations between the sets or groups of data.

### Hardware Architecture

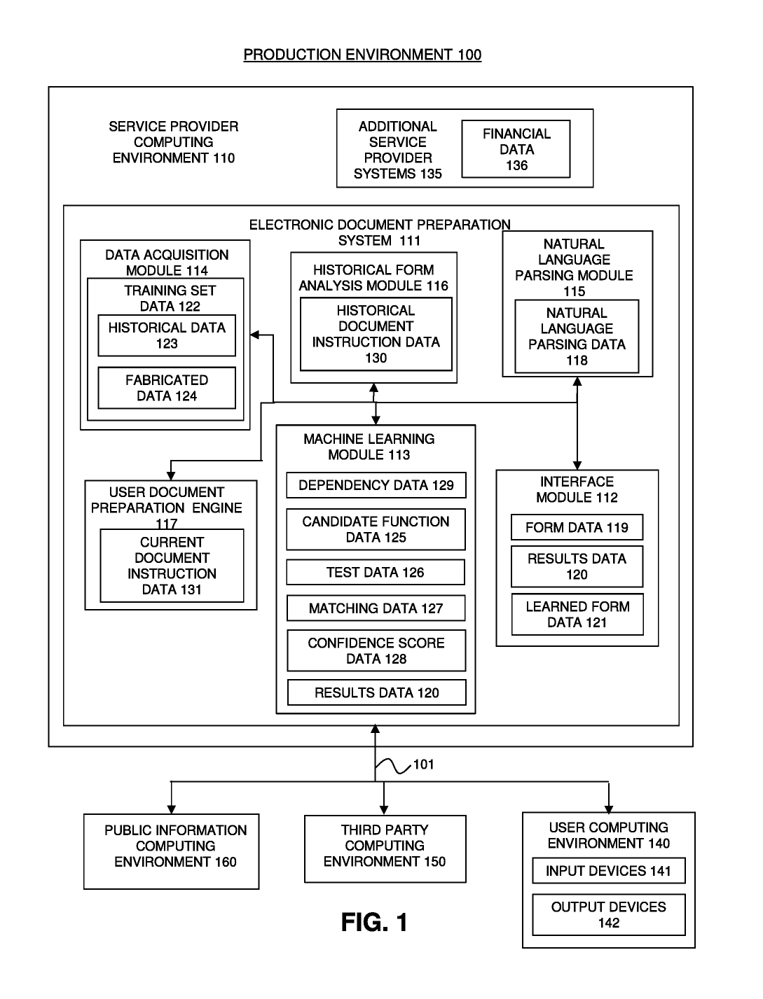

FIG. 1 illustrates a block diagram of a production environment 100 for learning and incorporating new and/or updated forms in an electronic document preparation system, according to one embodiment. Embodiments of the present disclosure provide methods and systems for learning and incorporating new and/or updated forms in an electronic document preparation system.

In particular, embodiments of the present disclosure receive form data related to a new and/or updated form having data fields to be completed according to instructions set forth in the new and/or updated form and utilize machine learning to parse and otherwise analyze natural language in a unique way and thereafter correctly determine and learn one or more computer executable functions equivalent to or otherwise represented by textual instructions for each data field. Those learned functions are then incorporated into the electronic document preparation system.

In one embodiment, training set data is used to test determined functions prior to incorporating a given function into the electronic document preparation system.

Embodiments discussed herein gather training set data including previously filled forms related to the new and/or updated form, and/or including fabricated data as discussed herein. One or more embodiments of the present disclosure determine or otherwise generate, for one or more data fields needing a new learned function, dependency data that indicates one or more dependencies likely to be included in an acceptable function for the data field.

Embodiments of the present disclosure utilize machine learning systems and processes use different techniques to generate candidate functions for data fields to be learned. The candidate functions may be based on the one or more dependencies and can include one or more operators selected from a set of operators. In one embodiment, the set of operators may be developed through natural language process operations discussed herein. The operators can operate on one or more of the possible dependencies and training set data. Embodiments of the present disclosure generate test data, i.e. output data, for each candidate function by applying the candidate function to one or more dependencies and/or the training set data.

Embodiments of the present disclosure compare the test data to the data values in the corresponding fields of the previously filled forms of the training set data or of the fabricated data. Embodiments of the present disclosure generate matching data indicating how closely the test data matches the data values of the previously filled forms of the training set data and/or how closely the test data matches the fabricated data, thus providing indicators of which of the candidate functions are optimum for a given form field.

In one embodiment, the machine learning processes continues generating candidate functions and test data until either one or more determined candidate functions are found that provide test data that matches the completed fields of the training set data within a predefined margin of error or until the process is terminated.

Embodiments of the present disclosure generate results data that indicates the best determined candidate functions for each data field of the new and/or updated form, based on how well test data from the best functions match the training set data. Embodiments of the present disclosure can output the results data for review by users who can review and approve the determined functions.

Additionally, or alternatively, embodiments of the present disclosure can determine when one or more acceptable candidate functions have been found and/or when the new and/or updated form has been entirely learned and can incorporate the new and/or updated form into a user document preparation engine so that users or customers of the electronic document preparation system can utilize the electronic document preparation system to electronically prepare documents involving the learned functions. By utilizing machine learning to learn and incorporate new and/or updated forms, efficiency of the electronic document preparation system is increased.

In addition, the disclosed method and system for learning and incorporating new and/or updated forms in an electronic document preparation system provides for significant improvements to the technical fields of electronic financial document preparation, data processing, data management, and user experience.

In addition, as discussed above, the disclosed method and system for learning and incorporating new and/or updated forms in an electronic document preparation system provide for the processing and storing of smaller amounts of data, i.e., more efficiently acquire and analyze forms and data, thereby eliminating unnecessary data analysis and storage. Consequently, using the disclosed method and system for learning and incorporating new and/or updated forms in an electronic document preparation system results in more efficient use of human and non-human resources, fewer processor cycles being utilized, reduced memory utilization, and less communications bandwidth being utilized to relay data to, and from, backend systems and client systems, and various investigative systems and parties. As a result, computing systems are transformed into faster, more efficient, and more effective computing systems by implementing the method and system for learning and incorporating new and/or updated forms in an electronic document preparation system.

In one embodiment, production environment 100 includes service provider computing environment 110, user computing environment 140, third party computing environment 150, and public information computing environments 160, for learning and incorporating new and/or updated forms in an electronic document preparation system, according to one embodiment. Computing environments 110, 140, 150, and 160 are communicatively coupled to each other with one or more communication channels 101, according to one embodiment.

Service provider computing environment 110 represents one or more computing systems such as a server or distribution center that is configured to receive, execute, and host one or more electronic document preparation systems (e.g., applications) for access by one or more users, for learning and incorporating new and/or updated forms in an electronic document preparation system, according to one embodiment. Service provider computing environment 110 represents a traditional data center computing environment, a virtual asset computing environment (e.g., a cloud computing environment), or a hybrid between a traditional data center computing environment and a virtual asset computing environment, according to one embodiment.

Service provider computing environment 110 includes electronic document preparation system 111 configured to provide electronic document preparation services to a user.

According to various embodiments, electronic document preparation system 111 is a system that assists in preparing financial documents related to one or more of tax return preparation, invoicing, payroll management, billing, banking, investments, loans, credit cards, real estate investments, retirement planning, bill pay, and budgeting. Electronic document preparation system 111 can be a tax return preparation system or other type of electronic document preparation system. Electronic document preparation system 111 can be a standalone system that provides financial document preparation services to users. Alternatively, electronic document preparation system 111 can be integrated into other software or service products provided by a service provider.

In one embodiment, electronic document preparation system 111 assists users in preparing documents related to one or more forms that include data fields to be completed by the user. The data fields may require data entries in accordance with specified instructions which can be represented by functions. Once the electronic document preparation system has learned functions that produce the required data entries for the data fields, the electronic document preparation system can assist individual users in electronically completing the form.

In many situations, such as in tax return preparation situations, state and federal governments or other financial institutions issue new or updated versions of standardized forms each year or even several times within a single year. Each time a new and/or updated form is released, electronic document preparation system 111 needs to learn the specific functions that provide the required data entries for one or more data fields in the new and/or updated form, such as a data field of a new or updated line associated with an updated form such as a new or updated tax form.

If these data fields are not correctly completed, there can be serious financial consequences for users. Furthermore, if electronic document preparation system 111 does not quickly learn and incorporate new and/or updated forms into electronic document preparation system 111, users of the electronic document preparation system 111 may turn to other forms of financial document preparation services. In traditional electronic document preparation systems, new and/or updated forms are learned and incorporated by financial professionals and/or experts manually reviewing the new and/or updated forms and manually revising software instructions to incorporate the new and/or updated forms. In some cases, this can be a slow, expensive, and unreliable system. Manually revising software instructions can take many man hours over many days or weeks, depending on the extent of the changes. Electronic document preparation system 111 of the present disclosure advantageously utilizes machine learning in addition to training set data in order to quickly and efficiently learn functions related to data fields of a form and incorporate those functions into electronic document preparation system 111.

According to one embodiment, electronic document preparation system 111 receives form data related to a new form or updated version of a previously known form. Electronic document preparation system 111 analyzes the form data and identifies data fields of the form. Electronic document preparation system 111 acquires training set data that is related to the new or updated version of the form. The training set data can include historical data of or related to previously prepared documents including copies of the form, or a related form, with one or more completed data fields. The previously prepared documents can include previously prepared documents that have already been filed with and approved by government or other institutions, or that were otherwise validated or approved.

Additionally, or alternatively, the training set data can include fabricated data that includes previously prepared documents using fictitious data or real data that has been scrubbed of personal identifiers or otherwise altered. Electronic document preparation system 111 utilizes machine learning in combination with the training set data to learn the functions that provide data entries for the data fields of the new and/or updated form.

In one embodiment, electronic document preparation system 111 identifies one or more dependencies for each data field to be learned. These dependencies can include one or more data values from other data fields of the new and/or updated form, one or more data values from another related form or worksheet, one or more constants, or many other kinds of dependencies that can be included in an acceptable function for a particular data field.

Electronic document preparation system 111 can identify the one or more possible dependencies based on natural language parsing of descriptive text included in the new and/or updated form and/or additional instructions and associated descriptive text provided with the new or updated form. Electronic document preparation system 111 can identify one or more possible dependencies by analyzing software from previous electronic document preparation systems that processed forms related to the new and/or updated form. Electronic document preparation system 111 can identify possible dependencies by receiving data from an expert, from a third party, or from another source.

In one embodiment, electronic document preparation system 111 generates, for each data field to be learned, one or more candidate functions based on the one or more dependencies and including one or more operators from a set of operators. Operators may represent any boolean, logical and/or mathematical operation, or any combination thereof. In various embodiments, operators include one or more of arithmetic operators such as addition, subtraction, multiplication, or division operators; logical operators such as if-then operators; existence condition operators that depend on the existence of a data value in another data field of new and/or updated form, in a form other than the new and/or updated form, or in some other location or data set; and string comparisons including greater than, less than and equal to, among others.

In one embodiment, once one or more candidate functions are generated, electronic document preparation system 111 generates test data by applying candidate functions to the training set data.

Electronic document preparation system 111 then generates matching data that indicates how closely the test data matches the training set data. When electronic document preparation system 111 finds a candidate function that results in test data that matches or closely matches the training set data within a predetermined margin of error, electronic document preparation system 111 can determine that the candidate function is an acceptable function for the particular data field of the new and/or updated form. The tax return preparation system then generates results data indicating whether the candidate function is acceptable and/or a fitness score, determined using a fitness function or an error function, or both, which may be used in a determination of a level of fitness, or a determination of a level of acceptability, for example

In one embodiment, electronic document preparation system 111 can generate and output results data for review. The results data can include one or more of the candidate functions that are determined to be acceptable functions, according to the matching data, for respective data fields of the new and/or updated form.

Electronic document preparation system 111 can request input from the expert to approve at least one of the acceptable candidate functions. Additionally, or alternatively, the electronic document preparation system 111 can automatically determine that the candidate function is acceptable, based on the matching data, and update electronic document preparation system 111 without review or approval. In this way, the electronic document preparation system can automatically learn and incorporate new or revised data fields and forms into electronic document preparation system 111.

Electronic document preparation system 111 includes interface module 112, machine learning module 113, data acquisition module 114, natural language parsing module 115, historical form analysis module 116, and user document preparation engine 117, according to one embodiment.

Interface module 112 is configured to receive form data 119 related to a new and/or updated form. Interface module 112 can receive the form data 119 from an expert, from a government agency, from a financial institution, or in other ways now known or later developed.

According to one embodiment, when a new and/or updated form is made available, an expert, other personnel, or other human or nonhuman resources of electronic document preparation system 111 can upload, scan and convert readable text using optical character recognition, or otherwise provide an electronic version of the form and/or other related documentation such as instructions to prepare one or more lines of the form, all part of form data 119, in various embodiments, to interface module 112. Interface module 112 can also receive form data 119 in an automated manner, such as by receiving automatic updates from an authority who designs or otherwise is responsible for establishing or updating the form, or in another way. The electronic version of the form is represented by form data 119. Form data 119, in various embodiments, includes one or more of one or more PDF documents, one or more HTML documents, one or more text documents, or other types of electronic document formats. The form data includes, in one embodiment, data related to data fields of the received form, limiting values, tables, or other data related to the new and/or updated form and its data fields that are used in the machine learning process.

Interface module 112 can also output results data 120 indicating the results of a machine learning process for particular candidate functions. The interface module 112 can also output learned form data 121 including one or more finalized learned functions, i.e. those functions that have been determined by processes discussed herein and which have been determined to be acceptable within a predetermined margin of error.

An expert obtains and reviews results data 120 and learned form data 121 from interface module 112, in one embodiment. Results data 120 or other test data is utilized, in one embodiment, by an expert and/or an automated system to use for other process operations discussed herein. For example: results data 120 or other test data is used, in one embodiment, by electronic document preparation system 111 or any other electronic document preparation system to test software instructions of the electronic document preparation system before making functionality associated with the software instructions available to the public.

The machine learning module 113 analyzes form data 119 in order to learn functions for the data fields of the new and/or updated form and incorporate them into electronic document preparation system 111. The machine learning module 113 generates results data 120 and learned form data 121.

In one embodiment, the machine learning module 113 is able to generate and test thousands of candidate functions very rapidly in successive iterations. The machine learning module 113 can utilize one or more algorithms to generate candidate functions based on many factors.

For example, machine learning module 113 can generate new candidate functions based on previously tested candidate functions. Inputs to the function generation process include, in one embodiment, outputs of the natural language processing process operations discussed herein.

In one embodiment, in a system where many candidate functions are generated and tested, components of a predetermined number of candidate functions that match the training data better than other candidate functions are used to generate new candidate functions which are then tested. In one embodiment, a component of a new candidate function includes one or more operators of the candidate function. In one embodiment, a component of a new candidate function includes one or more constants of the candidate function. In one embodiment, a component of a new candidate function includes one or more dependencies used to generate the candidate function.

In one embodiment, one or more of the predetermined number of candidate functions that match the training data better than other candidate functions are split into two or more components each, and the split components recombined into new candidate functions that are then tested to determine how well test data generated from those new candidate functions match the training set data. One or more of those new candidate functions that are determined to generate test data that match the training set data better than the original candidate functions may then again be split, if desired, and recombined into a second set of new candidate functions, and so on, until the resulting candidate functions produce test data that are deemed to match the training set data within a predetermined margin of error, as discussed herein. Thus, machine learning module 113 learns the components of the best functions and uses those components to quickly iterate towards an optimum solution. The machine learning module 113 can utilize analysis of the form data and/or other data to learn the best components of the candidate functions for a particular data field and can generate candidate functions based on these best components.

In one embodiment, the electronic document preparation system 111 uses data acquisition module 114 to acquire training set data 122. Training set data 122 includes, in various embodiments, previously prepared documents for one or more previous users of the electronic document preparation system 111 and/or fictitious users of the electronic document preparation system 111. Training set data 122 can be used by machine learning module 113 in order to learn and incorporate the new and/or updated form into electronic document preparation system 111.

In one embodiment, training set data 122 includes historical data 123 related to previously prepared documents or previously filed forms of one or more users. Historical data 123 can include, for each of a number of previous users of electronic document preparation system 111, a respective completed or partially completed copy of the new and/or updated form or a completed or partially completed copy of a form related to the new and/or updated form. The copies of the form include data values in at least the data fields for which one or more functions are to be determined.

In one embodiment, training set data 122 includes fabricated data 124. Fabricated data 124 includes, in one embodiment, copies of the new and/or updated form that were previously filled using fabricated data. The fabricated data of fabricated data 124 includes, in one embodiment, real data from previous users or other people that has been scrubbed of personal identifiers or otherwise altered. Further, fabricated data 124 includes, in one embodiment, data that matches the requirements of each data field and which may or may not have been used in a filing of a formal document with the authorities, such as with the Internal Revenue Service.

In one embodiment, historical data 123 and/or fabricated data 124 also includes related data used to complete the forms and to prepare the historical document, such as one or more worksheets or other subcomponents that are used to determine data values of one or more data fields of the training set data. The historical data 123 includes, in one embodiment, previously prepared documents that include or use completed form data which were filed with and/or approved by a government or other institution. In this way, a large portion of historical data 123 is highly accurate and properly prepared, though a small portion of the previously prepared documents might include errors. Typically, functions for computing or obtaining the proper data entry for a data field of a form include data values from other forms related to each other and sometimes complex ways. Thus, historical data 123 include, in one embodiment, for each historical user in the training set data, a final version of a previously prepared document, the form that is related to the new and/or updated form to be learned, other forms used to calculate the values for the related form, and other sources of data for completing the related form.

In one embodiment, electronic document preparation system 111 is a financial document preparation system. In this case, historical data 123 includes historical financial data. Historical data 123 includes, in one embodiment, for one or more historical users of electronic document preparation system 111, data representing one or more items associated with various users, i.e. the subjects of the electronic forms, such as, but not limited to, one or more of a name of the user, a name of the user's employer, an employer identification number (EID), a job title, annual income, salary and wages, bonuses, a Social Security number, a government identification, a driver's license number, a date of birth, an address, a zip code, home ownership status, marital status, W-2 income, an employer's address, spousal information, children's information, asset information, medical history, occupation, information regarding dependents, salary and wages, interest income, dividend income, business income, farm income, capital gain income, pension income, IRA distributions, education expenses, health savings account deductions, moving expenses, IRA deductions, student loan interest, tuition and fees, medical and dental expenses, state and local taxes, real estate taxes, personal property tax, mortgage interest, charitable contributions, casualty and theft losses, unreimbursed employee expenses, alternative minimum tax, foreign tax credit, education tax credits, retirement savings contribution, child tax credits, residential energy credits, item name and description, item purchase cost, date of purchase, and any other information that is currently used, that can be used, or that are used in the future, in a financial document preparation system or in the preparation of financial documents such as a user's tax return, according to various embodiments.

In one embodiment, data acquisition module 114 is configured to obtain or retrieve historical data 123 from one or more sources, including a large number of sources, e.g. 100 or more. The data acquisition module 114 retrieves, in one embodiment, from databases of electronic document preparation system 111, historical data 123 that has been previously obtained by electronic document preparation system 111 from third-party institutions. Additionally, or alternatively, data acquisition module 114 can retrieve historical data 123 afresh from the third-party institutions.

In one embodiment, data acquisition module 114 supplies or supplements historical data 123 by gathering pertinent data from other sources including third party computing environment 150, public information computing environment 160, additional service provider systems 135, data provided from historical users, data collected from user devices or accounts of electronic document preparation system 111, social media accounts, and/or various other sources to merge with or supplement historical data 123, according to various embodiments.

In one embodiment, data acquisition module 114 gathers additional data including historical financial data and third party data. For example, data acquisition module 114 is configured to communicate with additional service provider systems 135, e.g., a tax return preparation system, a payroll management system, or other electronic document preparation system, to access financial data 136, according to one embodiment. Data acquisition module 114 imports relevant portions of the financial data 136 into the electronic document preparation system 111 and, for example, saves local copies into one or more databases, according to one embodiment.

In one embodiment, additional service provider systems 135 include a personal electronic document preparation system, and data acquisition module 114 is configured to acquire financial data 136 for use by electronic document preparation system 111 in learning and incorporating the new or updated form into electronic document preparation system 111. Because the service provider provides both electronic document preparation system 111 and, for example, additional service provider systems 135, service provider computing environment 110 can be configured to share financial information between the various systems. By interfacing with additional service provider systems 135, data acquisition module 114 automatically and periodically supplies or supplements, in one embodiment, historical data 123 from financial data 136. Financial data 136 can include income data, investment data, property ownership data, retirement account data, age data, data regarding additional sources of income, marital status, number and ages of children or other dependents, geographic location, and other data that indicates personal and financial characteristics of users of other financial systems, according to one embodiment.

Data acquisition module 114 is configured to acquire additional information from various sources to merge with or supplement training set data 122, according to one embodiment. For example, data acquisition module 114 is configured, in one embodiment, to gather historical data 123 from various sources. For example, data acquisition module 114 is configured, in one embodiment, to communicate with additional service provider systems 135, e.g., a tax return preparation system, a payroll management system, or other financial management system, to access financial data 136, according to one embodiment. Data acquisition module 114 imports relevant portions of financial data 136 into the training set data 122 and, for example, saves local copies into one or more databases, according to one embodiment.

Data acquisition module 114 is configured to acquire additional financial data from the public information computing environment 160, according to one embodiment. The training set data is gathered, in one embodiment, from public record searches of tax records, public information databases, property ownership records, and other public sources of information. Data acquisition module 114 is also configured, in one embodiment, to also acquire data from sources such as social media websites, such as Twitter, Facebook, LinkedIn, and the like.

Data acquisition module 114 is configured to acquire data from third parties, according to one embodiment. For example, data acquisition module 114 requests and receives test data 126 from the third party computing environment 150 to supply or supplement training set data 122, according to one embodiment. In one embodiment, third party computing environment 140 is configured to automatically transmit financial data to electronic document preparation system 111 (e.g., to the data acquisition module 114), to be merged into training set data 122. The third party computing environment 140 can include, but is not limited to, financial service providers, state institutions, federal institutions, private employers, financial institutions, social media, and any other business, organization, or association that has maintained financial data, that currently maintains financial data, or which may in the future maintain financial data, according to one embodiment.

In one embodiment, electronic document preparation system 111 utilizes the machine learning module 113 to learn the data fields of the new and/or updated form in conjunction with training set data 122. Machine learning module 113 generates candidate functions for one or more data fields of the new and/or updated form to be learned and applies the candidate functions to the training set data 122 in order to find an acceptable candidate function that produces data values that match or closely match data values of the corresponding data fields of training set data 122.

In one embodiment, in a system wherein many candidate functions are generated and tested, components of a predetermined number of candidate functions that match the training data better than other candidate functions are used to generate new candidate functions which are then tested. In one embodiment, a component of a new candidate function includes one or more operators of the candidate function. In one embodiment, a component of a new candidate function includes one or more constants of the candidate function. In one embodiment, a component of a new candidate function includes one or more dependencies used to generate the candidate function.

In one embodiment, one or more of the predetermined number of candidate functions that match the training data better than other candidate functions are split into two or more components each, and the split components recombined into new candidate functions that are then tested to determine how well test data generated from those new candidate functions match the training set data. One or more of those new candidate functions that are determined to generate test data that match the training set data better than the original candidate functions may then again be split, if desired, and recombined into a second set of new candidate functions, and so on, until the resulting candidate functions produce test data that are deemed to match the training set data within a predetermined margin of error, as discussed herein. Thus, machine learning module 113 learns the components of the best functions and uses those components to quickly iterate towards an optimum solution.

In one embodiment, electronic document preparation system 111 identifies dependency data 129 including one or more possible dependencies for one or more data fields to be learned. These possible dependencies can include one or more data values from other data fields of the new and/or updated form, one or more data values from another related form or worksheet, one or more constants, or many other kinds of possible dependencies that can be included in an acceptable function for a particular data field.

In one embodiment, machine learning module 113 generates candidate functions based on dependency data 129 and one or more operators selected from a set of operators. The operators can include arithmetic operators such as addition, subtraction, multiplication, or division operators; logical operators such as if-then operators; existence condition operators that depend on the existence of a data value in another data field of new and/or updated form, in a form other than the new and/or updated form, or in some other location or data set; and string comparisons including greater than, less than and equal to, among others. Each candidate function can include one or more of the operators operating on one or more of the possible dependencies.

In one embodiment, machine learning module 113 learns acceptable functions for various data fields of a given form one at a time. In other words, if form data 119 indicates that a form has ten data fields for which functions are to be learned, machine learning module 113 will begin by learning an acceptable function for a first data field of the new and/or updated form before learning acceptable functions for other data fields of the same form. In particular, machine learning module 113 will generate candidate function data 125 corresponding to one or more candidate functions for the first data field of the new and/or updated form as represented by form data 119.

Machine learning module 113 also receives, in one embodiment, training set data 122 from data acquisition module 114. Training set data 122 includes, in one embodiment, data related to previously completed copies of an older version of the form to be learned or previously completed copies of a form closely related to the new and/or updated form to be learned. In particular, training set data 122 includes copies of the form that have a data entry in the data field that corresponds to the data field of the new and/or updated form currently being analyzed and learned by the machine learning module 113. Training set data 122 also includes data that was used to calculate the data values in the data field for each copy of the form or for each copy of the related form, e.g. W-2 data, income data, data related to other forms such as tax forms, payroll data, personal information, or any other kind of information that was used to complete the copies of the form or the copies of the related form in training set data 122. Machine learning module 113 generates test data 126 by applying each of the candidate functions to the training set data for the particular data field currently being learned. In particular, for each copy of the form or related form in training set data 122, machine learning module 113 applies the candidate function to at least a portion of the training set data related to the data field being learned in order to generate a test data value for the data field. Thus, if training set data 122 includes data values of 1000+ completed copies of the new and/or updated form or a related form, then machine learning module 113 will generate test data 126 that includes one test data value for the particular data field being analyzed for at least a portion of the 1000+ completed copies.

In one embodiment, machine learning module 113 then generates matching data 127 by comparing the test data value for each copy of the form to the actual data value from the completed data field of that copy of the form. Matching data 127 indicates how many of the test data values match their corresponding completed data value from training set data 122 within a predetermined margin of error.

In one embodiment, a fitness function is used to determine that one or more candidate functions are acceptable. In one embodiment, the fitness function includes an error function, such as a root mean square error function, reflecting errors that may be present in test data associated with one or more data sets of the training set data, as discussed herein. Other error functions currently known to those of ordinary skill or later developed may be used without departing from the scope of this disclosure. Other components of a fitness function include, according to various embodiments, one or more of how many operators are present in the candidate function, how many operators depend on results of other operators completing prior operations, whether there are missing arguments in the candidate function, and whether an argument is repeated in the candidate function. The tax return preparation system then generates results data indicating whether the candidate function is acceptable and/or a fitness score, determined using a fitness function or an error function, or both, which may be used in a determination of a level of fitness, or a determination of a level of acceptability, for example.

As explained above, in a system wherein many candidate functions are generated and tested, components of a predetermined number of candidate functions that match the training data better than other candidate functions are used to generate new candidate functions which are then tested. In one embodiment, a component of a new candidate function includes one or more operators of the candidate function. In one embodiment, a component of a new candidate function includes one or more constants of the candidate function. In one embodiment, a component of a new candidate function includes one or more dependencies used to generate the candidate function.

In one embodiment, one or more of the predetermined number of candidate functions that match the training data better than other candidate functions are split into two or more components each, and the split components recombined into new candidate functions that are then tested to determine how well test data generated from those new candidate functions match the training set data. One or more of those new candidate functions that are determined to generate test data that match the training set data better than the original candidate functions may then again be split, if desired, and recombined into a second set of new candidate functions, and so on, until the resulting candidate functions produce test data that are deemed to match the training set data within a predetermined margin of error, as discussed herein. Thus, machine learning module 113 learns the components of the best functions and uses those components to quickly iterate towards an optimum solution.

It is expected that training set data 122 may include some errors in the completed data values for the data field under test. Thus, an acceptable function operating on the test data may result in test data 126 that does not perfectly match the completed data fields in training set data 122. Thus, an acceptable candidate function will at least result in test data that matches the training set data within a predefined margin of error.

In one embodiment, a fitness function is used to determine that one or more candidate functions are acceptable. In one embodiment, the fitness function includes an error function, such as a root mean square error function, reflecting errors that may be present in test data associated with one or more data sets of the training set data, as discussed herein. Other error functions currently known to those of ordinary skill or later developed may be used without departing from the scope of this disclosure. Other components of a fitness function include, according to various embodiments, one or more of how many operators are present in the candidate function, how many operators depend on results of other operators completing prior operations, whether there are missing arguments in the candidate function, and whether an argument is repeated in the candidate function. The tax return preparation system then generates results data indicating whether the candidate function is acceptable and/or a fitness score, determined using a fitness function or an error function, or both, which may be used in a determination of a level of fitness, or a determination of a level of acceptability, for example.

In one embodiment, as discussed herein, the machine learning module 113 will continue to generate and test candidate functions until a candidate function has been found that results in test data that matches training set data 122 within the predefined margin of error. When at least one acceptable function has been found for the first data field, machine learning module 113 can repeat this process for a second data field, and so on, for each data field of the new and/or updated form to be learned.

In one embodiment, machine learning module 113 generates and tests candidate functions one at a time. Each time matching data 127 for a candidate function does indicates an error that exceeds the predefined margin of error, i.e. that the candidate function is not acceptable, machine learning module 113 may generate a new candidate function and tests the new candidate function.

In one embodiment, to form one or more new candidate functions, components of a predetermined number of previously formed candidate functions that match the training data better than other candidate functions, but perhaps not enough to be determined acceptable functions, are used to generate new candidate functions which are then tested. In one embodiment, a component of a new candidate function includes one or more operators of the previously formed candidate function. In one embodiment, a component of a new candidate function includes one or more constants of the previously formed candidate function. In one embodiment, a component of a new candidate function includes one or more dependencies used to generate the previously formed candidate function.

In one embodiment, one or more of the predetermined number of candidate functions that match the training data better than other candidate functions are split into two or more components each, and the split components recombined into new candidate functions that are then tested to determine how well test data generated from those new candidate functions match the training set data. One or more of those new candidate functions that are determined to generate test data that match the training set data better than the original candidate functions may then again be split, if desired, and recombined into a second set of new candidate functions, and so on, until one or more resulting candidate functions produce test data that are deemed to match the training set data within a predetermined margin of error, as discussed herein. Thus, machine learning module 113 learns the components of the best functions and uses those components to quickly iterate towards an optimum solution.

Machine learning module 113 can continue this process until an acceptable candidate function has been found. In this way, machine learning module 113 generates one or more acceptable candidate functions sequentially for each data field under test.

In one embodiment, machine learning module 113 can first generate candidate functions and then test each of the generated candidate functions. If matching data 127 indicates that none of the generated candidate functions is an acceptable candidate function, then machine learning module 113 can generate additional candidate functions and apply them to training set data 122. Machine learning module 113 can continue generating candidate functions and applying them to the training set data until an acceptable function has been found.

In one embodiment, the machine learning module generates candidate functions in successive iterations based on one or more algorithms. The successive iterations can be based on whether the matching data indicates that the candidate functions are becoming more accurate, such as in the successive iteration algorithm discussed herein where previously tested candidate functions are split into two or more components and recombined into new candidate functions. The machine learning module can continue to make adjustments to the candidate functions in directions that make the matching data more accurate until at least one acceptable function has been found.

In one embodiment, machine learning module 113 generates confidence score data 128 based on matching data 127. Confidence score data 128 can be based on matching data 127 and data regarding the candidate function itself. For example, the confidence score is adjusted downward, indicating that a less desirable candidate function has been found, if the candidate function uses an operator twice. The confidence score may further be adjusted downward, indicating that a less desirable candidate function has been found, for longer candidate functions, i.e. those functions having more operators. The confidence score may further be adjusted downward or upward based on how quickly a candidate function performs in its entirety. Other such adjustments may be used without departing from the teachings presented herein.

In one embodiment, machine learning module 113 generates results data 120. Results data 120 includes, in one embodiment, matching data 127 and/or confidence score data 128 for each candidate function that has been tested for one or more particular data fields of the new and/or updated form to be learned. Alternatively, results data 120 includes, in one embodiment, data indicating that one or more of the candidate functions is possibly acceptable based on matching data 127 and/or confidence score 128. Alternatively, results data 120 indicates, in one embodiment, that at least one acceptable function has been found. Results data 120 also indicates, in one embodiment, what the acceptable function is. Results data 120 can be provided to the interface module 112. Interface module 112 can output the results data 120 to a user, an expert, or other personnel for review and/or approval.

In one embodiment, machine learning module 113 outputs results data 120 indicating that a candidate function has been determined that is likely acceptable. Results data 120 then indicates, in one embodiment, what the determined candidate function is, matching data 127 and/or confidence score data 128 related to the determined candidate function, and/or any other information that will be useful for review by an expert. Machine learning module 113 can cause interface module 112 to prompt expert user or other individual to review results data 120 and to approve the determined candidate function as acceptable or to indicate that the determined candidate function is not acceptable and that machine learning module 113 should continue generating candidate functions for the data field currently under consideration. Machine learning module 113 awaits input from the expert or other personnel approving the candidate function. If the candidate function is approved by the expert or other personnel, machine learning module 113 determines that the acceptable candidate function has been found and moves on to finding an acceptable candidate function for a next data field of the new and/or updated form.

In one embodiment, machine learning module 113 does not wait for the approval of an expert before determining that an acceptable candidate function was found. Instead, when machine learning module 113 determines that an acceptable candidate function has been found based on the matching data, confidence score data 128, and/or other criteria, machine learning module 113 incorporates the acceptable candidate function into electronic document preparation system 111 and moves onto another data field of the new and/or updated form.

In one embodiment, when machine learning module 113 has learned an acceptable candidate function for data fields of the new and/or updated form that needed to be learned, then machine learning module 113 generates learned form data 121. Learned form data 121 indicates, in one embodiment, that the new and/or updated form has been learned. Learned form data 121 can also, in one embodiment, indicate what the acceptable candidate functions are for one or more of the data fields of the new and/or updated form. Interface module 112 can output, in one embodiment, learned form data 121 for review and/or approval by a user or expert. In one embodiment, once the user, expert or other personnel has approved learned form data 121, machine learning module 113 ceases analysis of the new and/or updated form and awaits form data 119 related to another function, form or form field to be learned.

In one embodiment, electronic document preparation system 111 includes a user document preparation engine 117. User document preparation engine 117 assists users of electronic document preparation system 111 to prepare a financial document based on or including the newly learned form as well as other forms. User document preparation engine 117 includes current document instructions data 131. Current document instructions data 131 includes, in one embodiment, software instructions, modules, engines, or other data or processes used to assist users of electronic document preparation system 111 in electronically preparing a document.

In one embodiment, once machine learning module 113 has fully learned one or more acceptable candidate functions for the data fields of a new and/or updated form, machine learning module 113 incorporates the newly learned form into electronic document preparation system 111 by updating current document instructions data 131. When current document instructions data 131 has been updated to include and recognize the new and/or updated form, users of the electronic document preparation system can electronically complete the new and/or updated form using electronic document preparation system 111. In this way, electronic document preparation system 111 quickly provides functionality that electronically complete the data fields of the new and/or updated form as part of preparing a financial document.

In one embodiment, user computing environment 140 is a computing environment related to a user of electronic document preparation system 111. User computing environment 140 includes, in various embodiments, input devices 141 and output devices 142 for communicating with the user, according one embodiment. Input devices 141 include, in various embodiments, but are not limited to, one or more of keyboards, mice, microphones, touchpads, touchscreens, digital pens, and the like. Output devices 142 include, in various embodiments, but are not limited to, one or more of speakers, monitors, touchscreens, and the like. Output devices 142 can, in one embodiment, display data related to the preparation of the financial document.

In one embodiment, machine learning module 113 can also generate interview content to assist in a financial document preparation interview. As a user utilizes electronic document preparation system 111 to prepare a financial document, user document preparation engine 117 may guide the user through a financial document preparation interview in order to assist the user in preparing the financial document. The interview content can include graphics, prompts, text, sound, or other electronic, visual, or audio content that assists the user to prepare the financial document. The interview content can prompt the user to provide data, to select relevant forms to be completed as part of the financial document preparation process, to explore financial topics, or otherwise assist the user in preparing the financial document. When machine learning module 113 learns acceptable functions for one or more data fields of a form, machine learning module 113 can also generate text or other types of audio or video prompts that describe the function and that can prompt the user to provide information that user document preparation engine 117 will use to complete the form. Thus, machine learning module 113 can generate interview content to assist in a financial document preparation interview.

In one embodiment, machine learning module 113 updates current document instruction data 131 once a new and/or updated form has been entirely learned without input or approval of an expert or other personnel. In one embodiment, machine learning module 113 updates current document instructions data 131 only after an expert has given approval that the new and/or updated form has properly learned.

In one embodiment, machine learning module 113 only learns acceptable functions for selected fields of a new and/or updated form. For example, machine learning module 113 is configured to perform machine learning processes to learn acceptable functions for certain types of data fields. Some types of data fields may not be as conducive to machine learning processes or for other reasons machine learning module 113 is configured to learn acceptable functions for only particular data fields of a new and/or updated form. In these cases, machine learning module 113 will only learn acceptable functions for certain selected data fields of the new and/or updated form. In some cases, machine learning module 113 may determine that it is unable to learn an acceptable function for one or more data fields after generating and testing many candidate functions for the one or more data fields. Results data 120 can therefore include data indicating that an acceptable function for a particular data field of the new and/or updated form cannot be learned by machine learning module 113.

In one embodiment, once form data 119 has been provided to electronic document preparation system 111, a user, expert or other personnel can input an indication of which data fields of the new and/or updated form should be learned by machine learning module 113. Machine learning module 113 will then only learn, in one embodiment, acceptable functions for those fields of the new and/or updated form that have been indicated by the user, expert or other personnel. In one embodiment, form data 119 can indicate which data fields machine learning module 113 should consider. In this way, machine learning module 113 only attempts to learn acceptable functions for the indicated data fields of a new and/or updated form.

In one embodiment, an acceptable function for a data field is simple or complex. A complex function may require that multiple data values be gathered from multiple places within other forms, the same form, from a user, or from other locations or databases. A complex function may also include mathematical relationships that will be applied to the multiple data values in complex ways in order to generate the proper data value for the data field. A function may include finding the minimum data value among two or more data values, finding the maximum data value among two or more data values, addition, subtraction, multiplication, division, exponential functions, logic functions, existence conditions, string comparisons, etc. The machine learning module 113 can generate and test complex candidate functions until an acceptable function has been found for a particular data field.

In one embodiment, new and/or updated forms may include data fields that expect data values that are alphabetical such as a first name, a last name, a middle name, a middle initial, a company name, a name of a spouse, a name of a child, a name of a dependent, a home address, a business address, a state of residence, the country of citizenship, or other types of data values that are generally alphabetic. In these cases, An acceptable function may include a person, a last name, a middle name, a middle initial, a company name, a name of a spouse, a name of a child, a name of a defendant, a home address, a business address, a state residence, the country citizenship, or other types of alphabetic data values. An acceptable function can also include a location from which these alphabetic data values are retrieved in other forms, worksheets, or financial related data otherwise provided by users or gathered from various sources.

The forms may also include data fields that expect data values that are numeric by nature. These expected data values may include incomes, tax withholdings, Social Security numbers, identification numbers, ages, loan payments, interest payments, charitable contributions, mortgage payments, dates, or other types of data values that are typically numeric in nature.

In one embodiment, machine learning module 113 can generate candidate functions for a particular data field based on dependency data that can provide an indication of the types of data that are likely to be included in an acceptable function and their likely location in other forms or data. For example, machine learning module 113 can utilize, in various embodiments, one or more of historical document instructions data 130, natural language parsing data 118, current document instruction data 131, and other types of contextual clues or hints in order to find a starting place for generating candidate functions. For this reason, the electronic document preparation system 111 can include a natural language parsing module 115 and the historical form analysis module 116.

In one embodiment, natural language parsing module 115 analyzes form data 119 with a natural language parsing process. In particular, natural language parsing module analyzes the text description associated with data fields of the new and/or updated form to be learned. For example, form data 119 may include text descriptions and/or form text for various data fields of the new and/or updated form. The text descriptions and form text originate from one or more different sources, such as, in the case of the new and/or updated for being a U.S. text form, from the IRS. The text descriptions and form text include, in one embodiment, text of one or more actual tax forms issued by the IRS and required to be filled out by taxpayers for which the new and/or updated form applies. The text descriptions and form text further include, in various embodiments, text of one or more instruction sets and publications issued by the IRS to assist the tax payer or tax preparer properly complete the form. Natural language parsing module 115 analyzes these text descriptions through process described herein and generates natural language parsing data 118 indicating the type of data value expected in each data field as well as function data indicating a hierarchical function representation formed as nodes and leaves of a tree. In various embodiments, the leaves of the function representation includes one or more form dependencies, such as constants, variables, and form/line dependencies where the function represented by the function representation depends on a results from data value associated with one or more different lines of the same form being analyzed, from a data value determined from a worksheet, or from one or more data values associated with one or more lines of a different tax form. Natural language parsing module 115 provides natural language parsing data 118 to machine learning module 113. Machine learning module 113 generates candidate functions for the various data fields based on the natural language parsing data 118. In this way, the machine learning module 113 utilizes the natural language parsing data 118 to assist in the machine learning process.

More particularly, embodiments include a computing system implemented method for learning and incorporating forms in an electronic document preparation system including receiving electronic textual data including instructions to determine one or more form field values of one or more forms of the plurality of forms. The method further includes, in one embodiment, analyzing the electronic textual data to determine sentence data representing separate sentences of the electronic textual data, and separating the electronic textual data into the determined separate sentences. Further, in one embodiment, for each sentence, extracting, for each given sentence of sentence data representing sentences in the data array, operand data representing one or more extracted operands of the sentence, and determining sentence fragment data for parts of speech for sentence fragments of the sentence including sentence fragment data representing word groups forming one or more parts of speech. Then, in one embodiment, separating sentence fragment data of the sentence containing verbs and sentence fragment data containing “if” or “minus” where the associated part of speech is either a prepositional phrase or a clause introduced by a subordinating conjunction, resulting in separated sentence fragment data.

Further, in one embodiment, for each token present in sentence data, removing any word present in exclusion data, filtering the sentence data to keep only tokens meeting at least one token test, and combining the filtered token data and the separated sentence fragment data and eliminating sentence fragments containing words from the exclusion data representing a predetermined exclusion list, resulting in filtered sentence fragment data. Finally, in one embodiment, replacing, within sentences of the data array, all single-word sentence fragments of the filtered sentence fragment data having similar meanings with a single word and extracting text-readable functions from sentences of the data array by matching predetermined patterns and replacing matched patterns with function data representing text-readable functions, converting the function data to computer readable functions, and implementing one or more of the computer readable functions in a document preparation system such as a tax preparation system.

In one embodiment, historical form analysis module 116 analyzes the form data 119 in order to determine if it is likely that previous versions of electronic document preparation system 111 included software instructions that computed data values for data fields of historical forms that are similar to the new and/or updated form. Accordingly, historical form analysis module 116 analyzes historical document instruction data 130 that includes software instructions from previous versions of electronic document preparation system 111. Because it is possible that the previous versions of the electronic document preparation system utilized software languages or structures that are now obsolete, historical document instructions data 130 may not easily or simply be analyzed or imported into current document instructions data 131. For this reason, historical form analysis module 116 can analyze, in one embodiment, historical document instructions data 130 related to historical forms that are similar to the new and/or updated form. Such historical forms may include previous versions of the new and/or updated form. Historical form analysis module 116 identifies, in one embodiment, from the outdated software language portions, complete acceptable functions related to data fields of the historical forms and generates, in one embodiment, historical instruction analysis data that indicates portions of or complete acceptable functions for the previous version of the form. Machine learning module 113 utilizes these instructions, in one embodiment, in order to find a starting point for generating the candidate functions in order to learn functions of data fields of the new and/or updated form.

In some cases, a new and/or updated form is nearly identical to a previous known version of the form. In these cases, training set data 122 can include historical data 123 that relates to previously prepared, filed, and/or approved financial documents that included or based on the previous known form. In these cases, data acquisition module 114 will gather training set data 122 that includes one or more previously completed copies of the previous version of the form. Machine learning module 113 generates the candidate functions and applies them to training set data 122 as described previously.

In some cases, a new and/or updated form may include data fields that are different enough that no analogous previously prepared financial documents are available to assist in the machine learning process. In one embodiment, data acquisition module 114 gathers training set data 122 that includes fabricated financial data 124. Fabricated financial data 124 can include copies of the new and/or updated form prepared with fabricated financial data by a third-party organization or a processor system associated with service provider computing environment 110. Fabricated financial data 124 can be used by machine learning module 113 in the machine learning process for learning acceptable functions associated with the data fields of the new and/or updated form. In such a case, the machine learning module generates candidate functions and applies them to training set data 122 including fabricated financial data 124 as described previously.

In one embodiment, training set data 122 can include both historical data 123 and fabricated financial data 124. In some cases, historical data 123 can include previously prepared documents as well as previously fabricated financial documents based on fictitious or real financial data.

In one embodiment, data acquisition module 114 gathers new training set data 122 each time a new data field of the new and/or updated form is to be analyzed by machine learning module 113. Data acquisition module 114 can gather a large training set data 122 including many thousands or millions of previously prepared or previously fabricated financial documents. When a new data field of a new and/or updated form is to be learned by machine learning module 113, data acquisition module 114 will gather training set data 122, or a subset of training set data 122, that includes a number of previously prepared financial documents that each have a data value in a data field of a form that corresponds to the data field of the new and/or updated form that is currently being learned by machine learning module 113. In some cases, training set data 122 includes, in one embodiment, a very large number, e.g. millions, of previously prepared financial documents, only a few hundred or thousands of the previously prepared documents are typically needed for analysis by machine learning module 113. Thus, data acquisition module 114 can gather training set data that is appropriate and efficient for machine learning module 113 to use the learning the current data field of the new and/or updated form.

In one embodiment, electronic document preparation system 111 is a tax return preparation system. Preparing a single tax return can require many government tax forms, internal worksheets used by the tax return preparation system in preparing a tax return, W-2 forms, and many other types of forms or financial data pertinent to the preparation of a tax return preparation system. For each tax return that is prepared for a user, the tax return preparation system maintains copies of various tax forms, internal worksheets, data provided by the user and any other relevant financial data used to prepare the tax return. Thus, the tax return preparation system typically maintains historical tax return data related to a large number of previously prepared tax returns. The tax return preparation system can utilize the historical tax return data to gather or generate relevant training set data 122 that can be used by machine learning module 113.

In one embodiment, a state or federal agency releases a new tax form that is simply a new version of a previous tax form during tax return preparation season. Form data 119 corresponds, in one embodiment, to an electronic version of the new version of the tax form. One or more of the data fields of the new tax form is similar to those of the previous tax form. Machine learning module 113 begins, in one embodiment, to learn the new tax form starting with a first selected data field of the new tax form. The first selected data field corresponds to a first selected line of the new tax form, not necessarily line 1 of the new tax form. Machine learning module 113 causes data acquisition module 114 to gather training set data 122 that includes a number of previously prepared tax returns and tax related data associated with the previously prepared tax returns. In particular, training set data 122 includes, in one embodiment, previously prepared tax returns that use a previous version of the new and/or updated form. Machine learning module 113 generates, in one embodiment, a plurality of candidate functions for the first selected data field and applies them to training set data 122. In one embodiment, machine learning module 113 uses the results of one or more natural language process operations discussed herein.

For each candidate function, machine learning module generates matching data 127 and/or confidence score data 128 indicating how well test data 126 matches training set data 122. Machine learning module 113 generates results data 120 indicating matching data 127 and/or confidence score data 128 of one or more of the candidate functions. Results data 120 can also indicate whether a candidate function is deemed to be an acceptable function for the first selected data field. If candidate functions have been tested and have not been deemed acceptable, additional new candidate functions are formed, with one or more of those new candidate functions being formed from components of one or more of the previous candidate functions.

In one embodiment, to form one or more new candidate functions, components of a predetermined number of previously formed candidate functions that match the training data better than other candidate functions, but perhaps not enough to be determined acceptable functions, are used to generate new candidate functions which are then tested. In one embodiment, a component of a new candidate function includes one or more operators of the previously formed candidate function. In one embodiment, a component of a new candidate function includes one or more constants of the previously formed candidate function. In one embodiment, a component of a new candidate function includes one or more dependencies used to generate the previously formed candidate function.

In one embodiment, one or more of the predetermined number of candidate functions that match the training data better than other candidate functions are split into two or more components each, and the split components recombined into new candidate functions that are then tested to determine how well test data generated from those new candidate functions match the training set data. One or more of those new candidate functions that are determined to generate test data that match the training set data better than the original candidate functions may then again be split, if desired, and recombined into a second set of new candidate functions, and so on, until one or more resulting candidate functions produce test data that are deemed to match the training set data within a predetermined margin of error, as discussed herein. Thus, machine learning module 113 learns the components of the best functions and uses those components to quickly iterate towards an optimum solution.

Machine learning module 113 moves onto a second selected data field after an acceptable function has been found for the first selected data field. In one embodiment, the data fields correspond to selected lines of the new tax form. Machine learning module 113 continues in this manner until functions relating to all selected data fields of the new tax form have been learned. Machine learning module 113 then generates learned form data 121 indicating that all selected fields of the new and/or updated form have been learned. Interface module 112 presents, in one embodiment, results data 120 and/or learned form data 121 for review and/or approval by an expert or other personnel. Alternatively, machine learning module 113 can move from one data field to the next data field without approval or review by an expert, as explained herein.

In one embodiment, the tax return preparation system receives form data 119 corresponding to a new and/or updated form for which an adequate previously known form cannot be found. In this case, data acquisition module 114 gathers training set data that can include fabricated financial data 124. The fabricated financial data 124 can include fictitious previously prepared tax returns and fabricated financial data that was used to prepare them. Data acquisition module 114 can obtain fabricated financial data 124 from one or more third parties, one or more associated tax return preparation systems, or in any other way. For example, the tax return preparation system can generate fabricated financial data 124 and provide it to one or more third parties to prepare a fabricated tax return using the new tax form. Fabricated financial data 124 includes, in one embodiment, one or more of data related to real users of the tax return preparation system, a script of actual identifiers such as real names, real Social Security numbers, etc. The third parties can then prepare tax returns from the fabricated financial data using the new and/or updated form. The third parties can then provide the fabricated tax returns to the tax return preparation system. The tax return preparation system can then utilize fabricated financial data 124 in conjunction with machine learning module 113 to learn the functions for the data fields of the new and/or updated form.

In one specific illustrative example, the tax return preparation system receives form data 119 related to a new tax form. Data acquisition module 114 gathers training set data 122 that at least includes historical tax return data related to previously prepared tax returns and or fabricated historical tax return data related to fabricated tax returns using the new form. In this example, machine learning module 113 undertakes to learn an acceptable function for generating the data value required by line 3 of the new tax form. Machine learning module 113 uses, in one embodiment, at least a portion of the dependency data that indicates that an acceptable function for line 3 is likely based on the values of line 31, line 2c, and the constants 3000 and 6000.

Training set data 122 includes, in one embodiment, previously completed copies of the new form or a related form having data values for line 3 that are believed to be correct. Training set data 122 also includes, in one embodiment, tax related data that were used to prepare the previously completed copies.

Machine learning module 113 generates at least one candidate function for line 3 of the new form and applies the candidate function(s) to training set data 122. In particular, machine learning module 113 generates test values of test data 126 by at least substituting at least a portion of the training set data for one or more of lines 31, 2c and the two constants, 3000 and 6000 in the candidate function for each subset of training set data for one or more of the previously completed copies, resulting in test values for line 3 of previously completed copies of the new or related form. Machine learning module 113 generates matching data by comparing the resulting test values to the actual completed data values for line 3 from training set data 122. Matching data 127 indicates how well the various test values match the actual values in line 3 of the previously completed forms. Thus, the comparison may include determining a margin of error relating to how well the test values match the actual values, or may include a straight comparison, such as subtracting one value from the other, or may include a more complex comparison, as desired by an implementer of the process operations discussed herein.

In one embodiment, a fitness function is used to determine that one or more candidate functions are acceptable. In one embodiment, the fitness function includes an error function, such as a root mean square error function, reflecting errors that may be present in test data associated with one or more data sets of the training set data, as discussed herein. Other error functions currently known to those of ordinary skill or later developed may be used without departing from the scope of this disclosure. Other components of a fitness function include, according to various embodiments, one or more of how many operators are present in the candidate function, how many operators depend on results of other operators completing prior operations, whether there are missing arguments in the candidate function, and whether an argument is repeated in the candidate function. The tax return preparation system then generates results data indicating whether the candidate function is acceptable and/or a fitness score, determined using a fitness function or an error function, or both, which may be used in a determination of a level of fitness, or a determination of a level of acceptability, for example.

In one embodiment, if matching data 127 indicates that at least portions of test data 126 matches training set data 122 within a predefined margin of error, then machine learning module 113 determines that the candidate function is acceptable. In the example, after one or more iterations of generating and testing candidate functions, the machine learning module may conclude that an acceptable function for line 3 is that if line 31 exists, then line 3 will be equal to line 31. Alternatively, if line 31 does not exist, then line 3 is the minimum of 6000 or 3000 multiplied by the value from line 2c.

In one embodiment, machine learning module 113 can also generate confidence score data 128 indicating a level of confidence that the candidate function is acceptable. Machine learning module 113 generates results data 120 that indicate that the candidate function is likely an acceptable function. Interface module 112 outputs results data 120 for review and/or approval by expert, other personnel, or other human and/or nonhuman resources. The expert or other personnel can approve the candidate function, causing machine learning module 113 to move to the next selected line of the new tax form. Alternatively, machine learning module 113 can decide that the candidate function is acceptable without approval from an expert or other personnel and can move onto the next selected line of the new tax form.

If matching data 127 indicates that the candidate function does not match the training set data well enough, then machine learning module 113 generates one or more other candidate functions and generates test data 126 by applying the one or more candidate functions to training set data 122 as described above.

In one embodiment, to form one or more new candidate functions, components of previously formed candidate functions that match the training data better than other candidate functions, but perhaps not enough to be determined acceptable functions, are used to generate new candidate functions which are then tested. In one embodiment, a component of a new candidate function includes one or more operators of the previously formed candidate function. In one embodiment, a component of a new candidate function includes one or more constants of the previously formed candidate function. In one embodiment, a component of a new candidate function includes one or more dependencies used to generate the previously formed candidate function.

In one embodiment, one or more of the predetermined number of candidate functions that match the training data better than other candidate functions are split into two or more components each, and the split components recombined into new candidate functions that are then tested to determine how well test data generated from those new candidate functions match the training set data. One or more of those new candidate functions that are determined to generate test data that match the training set data better than the original candidate functions may then again be split, if desired, and recombined into a second set of new candidate functions, and so on, until one or more resulting candidate functions produce test data that are deemed to match the training set data within a predetermined margin of error, thus determining that the one or more candidate functions are acceptable, as discussed herein. Thus, machine learning module 113 learns the components of the best functions and uses those components to quickly iterate towards an optimum solution.

Machine learning module 113 can continue to generate candidate functions in successive iterations until an acceptable candidate function has been found. Machine learning module 113 can continue from one line of the new tax form to the next until all selected lines of the tax form have been correctly learned by machine learning module 113.

In one embodiment, when all selected lines of the new tax form have been learned, machine learning module 113 generates learned form data 121 that indicates that the new tax form has been learned. Learned form data 121 can also include acceptable functions for each selected line of the new tax form. The interface module 112 can output learned form data 121 for review by an expert or other personnel.

In one embodiment, when the tax form has been learned by machine learning module 113, machine learning module 113 updates current document instructions data 131 to include software instructions for completing the new tax form as part of the tax return preparation process.

Embodiments of the present disclosure provide a technical solution to longstanding problems associated with traditional electronic document preparation systems that do not adequately learn and incorporate new and/or updated forms into the electronic document preparation system. An electronic document preparation system in accordance with one or more embodiments provides more reliable financial management services by utilizing machine learning and training set data to learn and incorporate new and/or updated forms into the electronic document preparation system. The various embodiments of the disclosure can be implemented to improve the technical fields of data processing, data collection, resource management, and user experience. Therefore, the various described embodiments of the disclosure and their associated benefits amount to significantly more than an abstract idea. In particular, by utilizing machine learning to learn and incorporate new and/or updated forms in the electronic document preparation system, electronic document preparation system can more efficiently learn and incorporate new and/or updated forms into the electronic document preparation system.

### Process

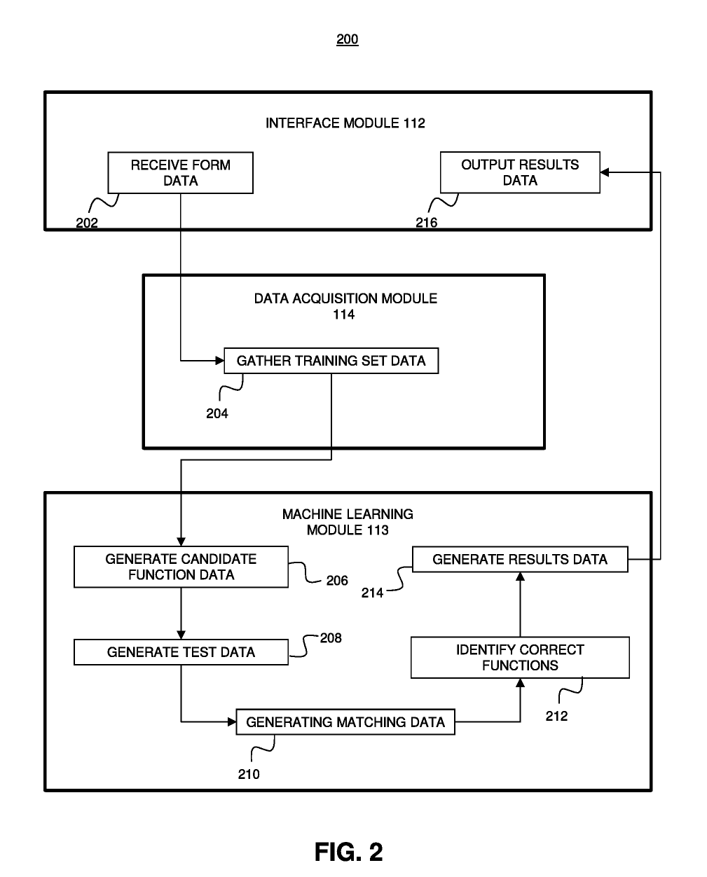

FIG. 2 illustrates a functional flow diagram of a process 200 for learning and incorporating new and/or updated forms in an electronic document preparation system, in accordance with one embodiment.

At block 202, the user interface module 112 receives form data related to a new and/or updated form having a plurality of data fields that expect data values in accordance with specific functions, according to one embodiment. From block 202 the process proceeds to block 204.

At block 204, data acquisition module 114 gathers training set data related to previously filled forms having completed data fields that each correspond to a respective data field of the new and/or updated form, according to one embodiment. From block 204, the process proceeds to block 206.

At block 206, machine learning module 113 generates candidate function data including, for one or more data fields of the new and/or updated form, at least one candidate function, according to one embodiment. From block 206, the process proceeds to block 208.

At block 208, machine learning module 113 generates test data by applying the candidate functions to the training set data, according to one embodiment. From block 208, the process proceeds to block 210.

At block 210, machine learning module 113 generates matching data indicating how closely each candidate function matches the test data, according to one embodiment.

In one embodiment, a fitness function is used to determine that one or more candidate functions are acceptable. In one embodiment, the fitness function includes an error function, such as a root mean square error function, reflecting errors that may be present in test data associated with one or more data sets of the training set data, as discussed herein. Other error functions currently known to those of ordinary skill or later developed may be used without departing from the scope of this disclosure. Other components of a fitness function include, according to various embodiments, one or more of how many operators are present in the candidate function, how many operators depend on results of other operators completing prior operations, whether there are missing arguments in the candidate function, and whether an argument is repeated in the candidate function. The tax return preparation system then generates results data indicating whether the candidate function is acceptable and/or a fitness score, determined using a fitness function or an error function, or both, which may be used in a determination of a level of fitness, or a determination of a level of acceptability, for example.

In one embodiment, to form one or more new candidate functions, components of previously formed candidate functions that match the training data better than other candidate functions, but perhaps not enough to be determined acceptable functions, are used to generate new candidate functions which are then tested. In one embodiment, a component of a new candidate function includes one or more operators of the previously formed candidate function. In one embodiment, a component of a new candidate function includes one or more constants of the previously formed candidate function. In one embodiment, a component of a new candidate function includes one or more dependencies used to generate the previously formed candidate function.

In one embodiment, one or more of the predetermined number of candidate functions that match the training data better than other candidate functions are split into two or more components each, and the split components recombined into new candidate functions that are then tested to determine how well test data generated from those new candidate functions match the training set data. One or more of those new candidate functions that are determined to generate test data that match the training set data better than the original candidate functions may then again be split, if desired, and recombined into a second set of new candidate functions, and so on, until one or more resulting candidate functions produce test data that are deemed to match the training set data within a predetermined margin of error, thus determining that the one or more candidate functions are acceptable, as discussed herein. Thus, machine learning module 113 learns the components of the best functions and uses those components to quickly iterate towards an optimum solution. As discussed herein, determination of acceptability of a given candidate function or the determination of the fitness of a given candidate function includes, in one embodiment, an error function such as a root mean square, for each data set of the training set data, as discussed below. Other considerations include, according to various embodiments, include one or more of how many operators are present in the candidate function, how many operators depend on results of other operators completing prior operations, whether there are missing arguments in the candidate function, and whether an argument is repeated in the candidate function.

From block 210, the process proceeds to block 212.

At block 212, machine learning module 113 identifies a respective acceptable function for each data field of the new and/or updated form based on the matching data. From block 212, the process proceeds to block 214.

At block 214, machine learning module 113 generates results data indicating an acceptable function for each data field of the new and/or updated form, according to one embodiment. From block 214 the process proceeds to block 216. At block 216, interface module 112 optionally outputs the results data for review by an expert or other personnel, according to one embodiment.

Although a particular sequence is described herein for the execution of the process 200, other process operations or different orders of sequences can also be implemented. For example, data acquisition module 114 can gather training set data each time a new data field of the new and/or updated form is to be learned. Machine learning module 113 can generate a single candidate function at a time and can generate test data and matching data for that candidate function and determine if the candidate function is acceptable based on the matching data. If the candidate function is not acceptable, machine learning module 113 returns to step 206 and generates a new candidate function, as discussed herein, and repeats the process until an acceptable function has been found for the data field currently being learned. When an acceptable function is found for a particular data field, data acquisition module 114 can again gather training set data for the next data field and the machine learning module 113 can generate, test, and analyze candidate functions until an acceptable function has been found. Machine learning module 113 can generate candidate functions based on dependency data that indicates one or more possible dependencies for an acceptable function for a given data field. Machine learning module 113 can generate candidate functions by selecting one or more operators from a library of operators. That library of operators may be selected from results, for example, of natural language processing operations discussed herein. Other sequences can also be implemented.

In one embodiment, following the determination of two or more candidate functions producing test data matching the training set data, a selection of a ‘most’ acceptable function may be desirable. In one embodiment, candidate functions producing test data matching the training set data are simplified, and candidate functions that contain the same operators, but which may have those operators in a different order, are combined into a single candidate function, and a desirability value is assigned to the resulting candidate function reflecting that the same candidate function was found more than once. The more times a same candidate function appears in results, the greater the desirability value. Further desirability values may be assigned or adjusted based on one or more other factors, in various embodiments, such as whether one operator or another is preferred for a given data field, whether a set of operators is preferred for a given data field, whether a particular type of operator is preferred for a given data field, and the like. Other factors known to those of ordinary skill may also be used in a desirability value determination, including factors that are later developed.

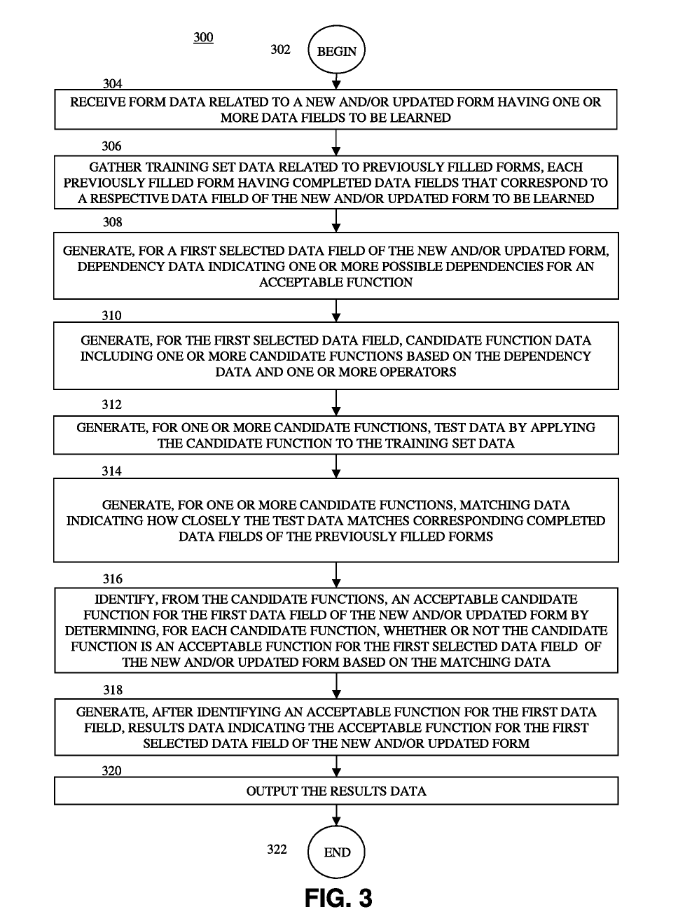

FIG. 3 illustrates a flow diagram of a process 300 for learning and incorporating new and/or updated forms in an electronic document preparation system, according to various embodiments.

In one embodiment, process 300 for learning and incorporating new and/or updated forms in an electronic document preparation system begins at BEGIN OPERATION 302 and process flow proceeds to RECEIVE FORM DATA RELATED TO A NEW AND/OR UPDATED FORM HAVING ONE OR MORE DATA FIELDS TO BE LEARNED OPERATION 304.

In one embodiment, at RECEIVE FORM DATA RELATED TO A NEW AND/OR UPDATED FORM HAVING ONE OR MORE DATA FIELDS TO BE LEARNED OPERATION 304 process 300 for learning and incorporating new and/or updated forms in an electronic document preparation system receives form data related to a new and/or updated form having one or more data fields to be learned.

In one embodiment, once process 300 for learning and incorporating new and/or updated forms in an electronic document preparation system receives form data related to a new and/or updated form having a plurality of data fields at RECEIVE FORM DATA RELATED TO A NEW AND/OR UPDATED FORM HAVING ONE OR MORE DATA FIELDS TO BE LEARNED OPERATION 304 process flow proceeds to GATHER TRAINING SET DATA RELATED TO PREVIOUSLY FILLED FORMS, EACH PREVIOUSLY FILLED FORM HAVING COMPLETED DATA FIELDS THAT CORRESPOND TO A RESPECTIVE DATA FIELD OF THE NEW AND/OR UPDATED FORM TO BE LEARNED OPERATION 306.

In one embodiment, at GATHER TRAINING SET DATA RELATED TO PREVIOUSLY FILLED FORMS, EACH PREVIOUSLY FILLED FORM HAVING COMPLETED DATA FIELDS THAT CORRESPOND TO A RESPECTIVE DATA FIELD OF THE NEW AND/OR UPDATED FORM TO BE LEARNED OPERATION 306, process 300 for learning and incorporating new and/or updated forms in an electronic document preparation system gathers training set data related to previously filled forms having one or more completed data fields that correspond to a data field of the new and/or updated form.

In one embodiment, one or more data values of the training set data representing previously filled forms is missing one or more data values, such as if a user previously filling in a first form didn't prepare a predicate form that relates to the current form being learned. In this case, a missing data value might be zero, or might be something different, but it is often not desirable to guess a data value to be substituted for that missing data value. Rather, in one embodiment, a known placeholder value is substituted for the missing data value, such as either a high positive value or high negative value, such as −99999 being substituted for the missing data value, in a data set of the training set data. In such circumstances, process 300 is configured to understand that a particular high positive value in a data set, or a particular high negative value indicates a missing data value in a given data set of the training set data.

In one embodiment, where an acceptable candidate function for a given data field of a form is expected to be complicated, one or more missing data values within a data set of the training data are replaced by a two-variable pair formed of a boolean value and a float value where the boolean value is set to ‘true’ if the data associated with the missing data value exists and the associated float value is set to the filled data value, and the boolean value is set to ‘false’ if the field associated with the missing data value is missing and the associated float value is set to a predetermined known placeholder value, such as −99999 discussed above.

In one embodiment, once process 300 for learning and incorporating new and/or updated forms in an electronic document preparation system gathers training set data related to previously filled forms at GATHER TRAINING SET DATA RELATED TO PREVIOUSLY FILLED FORMS, EACH PREVIOUSLY FILLED FORM HAVING COMPLETED DATA FIELDS THAT CORRESPOND TO A RESPECTIVE DATA FIELD OF THE NEW AND/OR UPDATED FORM TO BE LEARNED OPERATION 306, process flow proceeds to GENERATE, FOR A FIRST SELECTED DATA FIELD OF THE NEW AND/OR UPDATED FORM, DEPENDENCY DATA INDICATING ONE OR MORE POSSIBLE DEPENDENCIES FOR AN ACCEPTABLE FUNCTION OPERATION 308.

In one embodiment, at GENERATE, FOR A FIRST SELECTED DATA FIELD OF THE NEW AND/OR UPDATED FORM, DEPENDENCY DATA INDICATING ONE OR MORE POSSIBLE DEPENDENCIES FOR AN ACCEPTABLE FUNCTION OPERATION 308, process 300 for learning and incorporating new and/or updated forms in an electronic document preparation system generates, for a first selected data field of the plurality of data fields of the new and/or updated form, dependency data indicating one or more possible dependencies for an acceptable function that provides a proper data value for the first selected data field.

In one embodiment, once process 300 for learning and incorporating new and/or updated forms in an electronic document preparation system generates, for a first selected data field of the plurality of data fields of the new and/or updated form, dependency data indicating one or more possible dependencies for an acceptable function that provides a proper data value for the first selected data field at GENERATE, FOR A FIRST SELECTED DATA FIELD OF THE NEW AND/OR UPDATED FORM, DEPENDENCY DATA INDICATING ONE OR MORE POSSIBLE DEPENDENCIES FOR AN ACCEPTABLE FUNCTION OPERATION 308, process flow proceeds to GENERATE, FOR THE FIRST SELECTED DATA FIELD, CANDIDATE FUNCTION DATA INCLUDING ONE OR MORE CANDIDATE FUNCTIONS BASED ON THE DEPENDENCY DATA AND ONE OR MORE OPERATORS OPERATION 310.

In one embodiment, at GENERATE, FOR THE FIRST SELECTED DATA FIELD, CANDIDATE FUNCTION DATA INCLUDING ONE OR MORE CANDIDATE FUNCTIONS BASED ON THE DEPENDENCY DATA AND ONE OR MORE OPERATORS OPERATION 310, process 300 for learning and incorporating new and/or updated forms in an electronic document preparation system generates, for the first selected data field, candidate function data including one or more candidate functions based on the dependency data and one or more operators. The candidate functions include, in various embodiments, one or more operators selected from a set of operators which includes logical and mathematical functionality. The operators include, in various embodiments, arithmetic operators such as addition, subtraction, multiplication, division or other mathematical operators, exponential functions, logical operators such as if-then operators, and/or Boolean operators such as true/false. The operators can include existence condition operators that depend on the existence of a data value in another data field of new and/or updated form, in a form other than the new and/or updated form, or in some other location or data set. The operators can include string comparisons and/or rounding or truncating operations, or operators representing any other functional operation that can operate on dependencies and constants to provide a suitable output data value for the data field being learned.

In one embodiment, once process 300 for learning and incorporating new and/or updated forms in an electronic document preparation system generates, for the first selected data field, candidate function data including one or more candidate functions based on the dependency data and one or more operators selected from a set of operators at GENERATE, FOR THE FIRST SELECTED DATA FIELD, CANDIDATE FUNCTION DATA INCLUDING ONE OR MORE CANDIDATE FUNCTIONS BASED ON THE DEPENDENCY DATA AND ONE OR MORE OPERATORS OPERATION 310, process flow proceeds to GENERATE, FOR ONE OR MORE CANDIDATE FUNCTIONS, TEST DATA BY APPLYING THE CANDIDATE FUNCTION TO THE TRAINING SET DATA OPERATION 312.

In one embodiment, at GENERATE, FOR ONE OR MORE CANDIDATE FUNCTIONS, TEST DATA BY APPLYING THE CANDIDATE FUNCTION TO THE TRAINING SET DATA OPERATION 312 the process 300 generates, for each candidate function, test data by applying the candidate function to the training set data. The machine learning module 113 of FIG. 1 generates test values of test data 126, in one embodiment, by substituting at least a portion of the training set data for one or more of lines 31 and 2c in the candidate function and determining a result of performing the candidate function.

In one embodiment, once process 300 generates, for each candidate function, test data by applying the candidate function to the training set data at GENERATE, FOR ONE OR MORE CANDIDATE FUNCTIONS, TEST DATA BY APPLYING THE CANDIDATE FUNCTION TO THE TRAINING SET DATA OPERATION 312 of FIG. 3, process flow proceeds to GENERATE, FOR ONE OR MORE CANDIDATE FUNCTIONS, MATCHING DATA INDICATING HOW CLOSELY THE TEST DATA MATCHES CORRESPONDING COMPLETED DATA FIELDS OF THE PREVIOUSLY FILLED FORMS OPERATION 314.

In one embodiment, at GENERATE, FOR ONE OR MORE CANDIDATE FUNCTIONS, MATCHING DATA INDICATING HOW CLOSELY THE TEST DATA MATCHES CORRESPONDING COMPLETED DATA FIELDS OF THE PREVIOUSLY FILLED FORMS OPERATION 314 the process 300 for learning and incorporating new and/or updated forms in an electronic document preparation system generates, for one or more candidate functions being learned, matching data. In one embodiment, the matching data is generated by comparing the test data to training set data corresponding to the first selected data field, the matching data indicating how closely the test data matches the corresponding completed data fields of the previously filled forms.

In one embodiment, a fitness function is used to determine whether one or more candidate functions are acceptable. In one embodiment, the fitness function includes consideration of an error function such as a square root of the sum of the squares of the differences between the desired output of a candidate function and the actual output of the candidate function, for each data set of the training set data, as discussed below. Other considerations included in a fitness function, according to various embodiments, are one or more of how many operators are present in the candidate function, how many operators depend on results of other operators completing prior operations, whether there are missing arguments in the candidate function, and whether an argument is repeated in the candidate function.

In one embodiment, once the process 300 for learning and incorporating new and/or updated forms in an electronic document preparation system generates, for each candidate function, matching data by comparing the test data to the completed data fields corresponding to the first selected data field, the matching data indicating how closely the test data matches the corresponding completed data fields of the previously filled forms at GENERATE, FOR ONE OR MORE CANDIDATE FUNCTIONS, MATCHING DATA INDICATING HOW CLOSELY THE TEST DATA MATCHES CORRESPONDING COMPLETED DATA FIELDS OF THE PREVIOUSLY FILLED FORMS OPERATION 314, process flow proceeds to IDENTIFY, FROM THE CANDIDATE FUNCTIONS, AN ACCEPTABLE CANDIDATE FUNCTION FOR THE FIRST DATA FIELD OF THE NEW AND/OR UPDATED FORM BY DETERMINING, FOR EACH CANDIDATE FUNCTION, WHETHER OR NOT THE CANDIDATE FUNCTION IS AN ACCEPTABLE FUNCTION FOR THE FIRST SELECTED DATA FIELD OF THE NEW AND/OR UPDATED FORM BASED ON THE MATCHING DATA OPERATION 316.

In one embodiment, at IDENTIFY, FROM THE CANDIDATE FUNCTIONS, AN ACCEPTABLE CANDIDATE FUNCTION FOR THE FIRST DATA FIELD OF THE NEW AND/OR UPDATED FORM BY DETERMINING, FOR EACH CANDIDATE FUNCTION, WHETHER OR NOT THE CANDIDATE FUNCTION IS AN ACCEPTABLE FUNCTION FOR THE FIRST SELECTED DATA FIELD OF THE NEW AND/OR UPDATED FORM BASED ON THE MATCHING DATA OPERATION 316 process 300 for learning and incorporating new and/or updated forms in an electronic document preparation system identifies, from the plurality of functions, an acceptable candidate function for the first data field of the new and/or updated form by determining, for the various candidate functions, whether or not the candidate function is an acceptable function for the first selected data field of the new and/or updated form based on the matching data.

If, at IDENTIFY, FROM THE CANDIDATE FUNCTIONS, AN ACCEPTABLE CANDIDATE FUNCTION FOR THE FIRST DATA FIELD OF THE NEW AND/OR UPDATED FORM BY DETERMINING, FOR EACH CANDIDATE FUNCTION, WHETHER OR NOT THE CANDIDATE FUNCTION IS AN ACCEPTABLE FUNCTION FOR THE FIRST SELECTED DATA FIELD OF THE NEW AND/OR UPDATED FORM BASED ON THE MATCHING DATA OPERATION 316, the matching data may indicate that there are no acceptable candidate functions among the candidate functions being considered. If so, new candidate functions are generated and considered.

In one embodiment, to form one or more new candidate functions, components of previously formed candidate functions, such as previously formed candidate functions that match the training data better than other candidate functions but perhaps not enough to be determined acceptable functions, are used to generate new candidate functions which are then tested. In one embodiment, a component of a new candidate function includes one or more operators of a previously formed candidate function. In one embodiment, a component of a new candidate function includes one or more constants of the previously formed candidate function. In one embodiment, a component of a new candidate function includes one or more dependencies used to generate the previously formed candidate function.

In one embodiment, one or more of the predetermined number of candidate functions that match the training data better than other candidate functions are split into two or more components each, and the split components recombined into new candidate functions that are then tested to determine how well test data generated from those new candidate functions match the training set data. One or more of those new candidate functions that are determined to generate test data that match the training set data better than the original candidate functions may then again be split, if desired, and recombined into a second set of new candidate functions, and so on, until one or more resulting candidate functions produce test data that are deemed to match the training set data within a predetermined margin of error, as discussed herein. Thus, machine learning module 113 of FIG. 1 learns the components of the best functions and uses those components to quickly iterate towards an optimum solution.

In one embodiment, once the process 300 for learning and incorporating new and/or updated forms in an electronic document preparation system identifies, from the plurality of functions, an acceptable candidate function for the first data field of the new and/or updated form by determining, for each candidate function, whether or not the candidate function is an acceptable function for the first selected data field of the new and/or updated form based on the matching data at IDENTIFY, FROM THE CANDIDATE FUNCTIONS, AN ACCEPTABLE CANDIDATE FUNCTION FOR THE FIRST DATA FIELD OF THE NEW AND/OR UPDATED FORM BY DETERMINING, FOR EACH CANDIDATE FUNCTION, WHETHER OR NOT THE CANDIDATE FUNCTION IS AN ACCEPTABLE FUNCTION FOR THE FIRST SELECTED DATA FIELD OF THE NEW AND/OR UPDATED FORM BASED ON THE MATCHING DATA OPERATION 316, process flow proceeds to GENERATE, AFTER IDENTIFYING AN ACCEPTABLE FUNCTION FOR THE FIRST DATA FIELD, RESULTS DATA INDICATING THE ACCEPTABLE FUNCTION FOR THE FIRST SELECTED DATA FIELD OF THE NEW AND/OR UPDATED FORM OPERATION 318.

In one embodiment, at GENERATE, AFTER IDENTIFYING AN ACCEPTABLE FUNCTION FOR THE FIRST DATA FIELD, RESULTS DATA INDICATING THE ACCEPTABLE FUNCTION FOR THE FIRST SELECTED DATA FIELD OF THE NEW AND/OR UPDATED FORM OPERATION 318, process 300 for learning and incorporating new and/or updated forms in an electronic document preparation system generates, after identifying an acceptable function for the first data field, results data indicating the acceptable function for the first selected data field of the new and/or updated form. If more than one acceptable function has been found, the results data may optionally include more than one of the identified acceptable functions.

In one embodiment, once process 300 for learning and incorporating new and/or updated forms in an electronic document preparation system generates, after identifying an acceptable function for the first selected data field, results data indicating the acceptable function for the first data field of the new and/or updated form at GENERATE, AFTER IDENTIFYING AN ACCEPTABLE FUNCTION FOR THE FIRST DATA FIELD, RESULTS DATA INDICATING THE ACCEPTABLE FUNCTION FOR THE FIRST SELECTED DATA FIELD OF THE NEW AND/OR UPDATED FORM OPERATION 318 proceeds to OUTPUT THE RESULTS DATA OPERATION 320.

In one embodiment, at OUTPUT THE RESULTS DATA OPERATION 320 the process 300 for learning and incorporating new and/or updated forms in an electronic document preparation system outputs the results data.

In one embodiment, once the process 300 for learning and incorporating new and/or updated forms in an electronic document preparation system outputs the results data at OUTPUT THE RESULTS DATA OPERATION 320, process flow proceeds to END OPERATION 322.

In one embodiment, at END OPERATION 322 the process for learning and incorporating new and/or updated forms in an electronic document preparation system is exited to await new data and/or instructions.

In one embodiment, following the determination of two or more candidate functions producing test data matching the training set data, a selection of a ‘most’ acceptable function may be desirable. In one embodiment, candidate functions producing test data matching the training set data are simplified, and candidate functions that contain the same operators, but which may have those operators in a different order, are combined into a single candidate function, and a desirability value is assigned to the resulting candidate function reflecting that the same candidate function was found more than once. The more times a same candidate function appears in results, the greater the desirability value. Further desirability values may be assigned or adjusted based on one or more other factors, in various embodiments, such as whether one operator or another is preferred for a given data field, whether a set of operators is preferred for a given data field, whether a particular type of operator is preferred for a given data field, and the like. Other factors known to those of ordinary skill may also be used in a desirability value determination, including factors that are later developed.

In one embodiment, there is a need to identify specific candidate functions that perform better, i.e. have a lower error or otherwise have test results that differ from the training set data less than other candidate functions, and use one or more components of those specific candidate functions to form new candidate functions, in order to arrive at an acceptable solution very quickly.

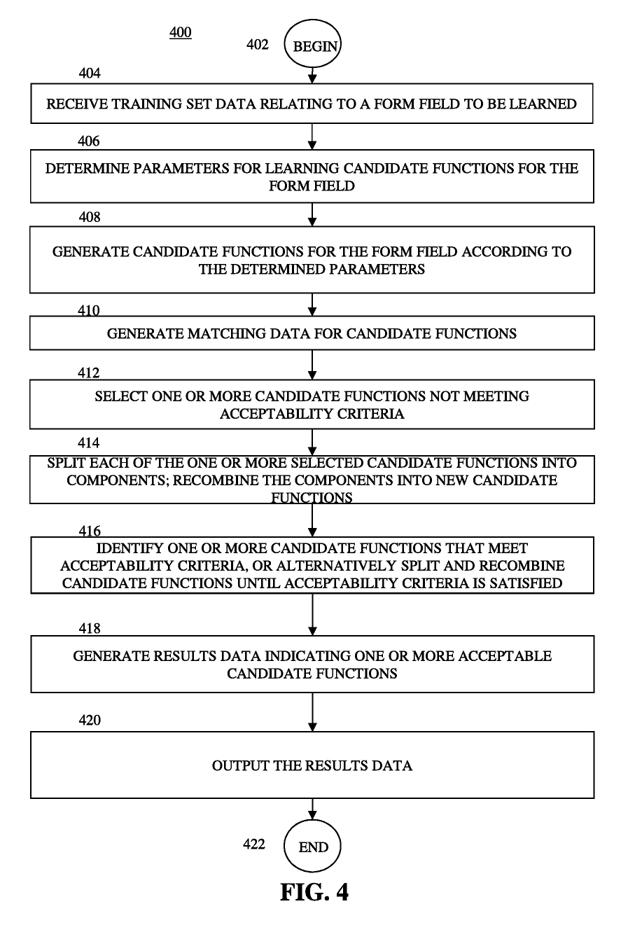

FIG. 4 is a flow diagram of a process 400 for learning and incorporating new and/or updated forms in an electronic document preparation system, in accordance with one embodiment.

In one embodiment, process 400 for learning and incorporating new and/or updated forms in an electronic document preparation system begins at BEGIN OPERATION 402 and process flow proceeds to RECEIVE TRAINING SET DATA RELATING TO A FORM FIELD TO BE LEARNED OPERATION 404.

In one embodiment, at RECEIVE TRAINING SET DATA RELATING TO A FORM FIELD TO BE LEARNED OPERATION 404, training set data is received as discussed above with respect to GATHER TRAINING SET DATA RELATED TO PREVIOUSLY FILLED FORMS, EACH PREVIOUSLY FILLED FORM HAVING COMPLETED DATA FIELDS THAT CORRESPOND TO A RESPECTIVE DATA FIELD OF THE NEW AND/OR UPDATED FORM TO BE LEARNED OPERATION 306 of FIG. 3. Here, we are focusing our example on a single data field of a form to be learned, and thus only need training set data of the single data field to be learned, including training set data for any other data fields that are used in the determination of a data value for the single data field being learned. For example, if a data field for line 5 of a given form is being learned, and line 5 depends from line 2b of the same form and line 12 of a different form, the training set data will include many different sets of data, where those sets of data ideally include at least lines 2b and 12, and also data from line 5, the field being learned.

The received training set data will typically include hundreds, thousands, or possibly even millions of sets of data from previously filed tax returns, or from other data sources, depending on the character of the data field being learned. In some instances, a large number of data sets of the received training set data is duplicative, i.e. uses identical data values in lines 2b and 12, for example, thus resulting in the same training set value for line 5 as well. In one embodiment, the received training set data is processed to eliminate duplicate data sets, retaining only one copy for use in learning a function for line 5. Further, in situations where there is a bound placed on data values allowed of a given data field, and where the training set data includes data values outside of that bound, it may be beneficial to eliminate data sets from the training set data those data sets that have data values exceeding that bound. In one embodiment, where line 2b of the example above is only allowed to be a positive number, any data sets of the training set data that have a negative number for line 2b is eliminated from the received training set data. Other observations may also be made, automatically by a computing system, such as determining that one or more of the data values of one or more data sets are zero, such as if one or more of line 2b or line 12 is zero in those data sets. If the number of data sets having a data value of zero is large, it may be advantageous in some situations to eliminate all but a few such data sets, thus reducing the data sets of the training set data. By reducing the number of data sets being used to learn functions, significant time savings is achieved, in addition to significantly reducing memory requirements and processor cycles needed to accomplish the processes described herein.

Further details on forming training data sets may be found in the U.S. patent application filed Oct. 13, 2016 having attorney docket number INTU179969, Ser. No. 15/292,510, and entitled SYSTEM AND METHOD FOR SELECTING DATA SAMPLE GROUPS FOR MACHINE LEARNING OF CONTEXT OF DATA FIELDS FOR VARIOUS DOCUMENT TYPES AND/OR FOR TEST DATA GENERATION FOR QUALITY ASSURANCE SYSTEMS naming inventor Cem Unsal which is incorporated herein by reference in its entirety as if it was fully set forth herein.

In one embodiment, following the receipt of training set data at RECEIVE TRAINING SET DATA RELATING TO A FORM FIELD TO BE LEARNED OPERATION 404 of FIG. 4, process flow proceeds to DETERMINE PARAMETERS FOR LEARNING CANDIDATE FUNCTIONS FOR THE FORM FIELD OPERATION 406.

In one embodiment, at DETERMINE PARAMETERS FOR LEARNING CANDIDATE FUNCTIONS FOR THE FORM FIELD OPERATION 406, one or more parameters to be incorporated into the learning process are determined. In some embodiments, limits are placed on the number of functions to be generated and tested in a single cycle of the process. For example, it may be desirable to generate and test no more than 200 functions at a time, and then rank those functions according to how closely test data from those functions match the training set data for the particular line of a form associated with the function. In one or more embodiments, if a given form is likely to have less complex functions that can be used to determine one or more data values associated with various data fields of the form, it may be desirable to limit the number of operators to be used in a given candidate function. In a third example, it may be desirable in some circumstances to limit the number of times particular operators are used in a given candidate function. Thus, according to these examples, parameters that may be used in a given instance of the process may include one or more of a maximum number of functions to be generated and tested in a given cycle of the process, a maximum number of operators to be used in candidate functions generated and tested in a given cycle of the process, a maximum total number of candidate functions to be generated and tested prior to the process pausing and presenting results data to a user or other expert, a maximum number of rounds of generating and testing candidate functions, and a maximum number of times particular operators are used in a given candidate function, or any combination thereof. Other parameters may be developed and used in the processes described herein without departing from the teachings of the present disclosure. In this disclosure, the parameters further include, but are not limited to the dependencies discussed herein.

In one embodiment, following the determination of one or more parameters to be incorporated into the function learning process at DETERMINE PARAMETERS FOR LEARNING CANDIDATE FUNCTIONS FOR THE FORM FIELD 406, process flow proceeds at GENERATE CANDIDATE FUNCTIONS FOR THE FORM FIELD ACCORDING TO THE DETERMINED PARAMETERS OPERATION 408.

In one embodiment, at GENERATE CANDIDATE FUNCTIONS FOR THE FORM FIELD ACCORDING TO THE DETERMINED PARAMETERS OPERATION 408, one or more candidate functions are generated according to the parameters determined at DETERMINE PARAMETERS FOR LEARNING CANDIDATE FUNCTIONS FOR THE FORM FIELD OPERATION 406. If, for example, a parameter indicates a maximum number of candidate functions to be tested in a given cycle of the process is one hundred, only one hundred or fewer candidate functions are generated at a time. Further, if there is also a parameter indicating that the maximum number of operators in a given candidate function is twenty, then each generated candidate function will contain twenty or fewer operators. If, as a third example, a parameter indicates a maximum number of times a given operator may appear in a given candidate function is four, then each generated candidate function will not generate any candidate functions having any particular operator appearing more than four times. As discussed above, the parameters may also include dependencies, such as other lines that a data field of the current line needs to be determined correctly. Therefore, in one embodiment, candidate functions generated at GENERATE CANDIDATE FUNCTIONS FOR THE FORM FIELD ACCORDING TO THE DETERMINED PARAMETERS OPERATION 408 will include consideration of those dependencies. For example, a data field depending on line 2 and having a constant of 3000 will consider, and perhaps include, one or more of those dependencies when generating the candidate functions. It is not necessarily true that each dependency will be overtly present in each candidate function. It has been seen, for example, that a seemingly complex line in a tax return that has complicated accompanying instructions depending on many factors may actually be able to be determined with a single operator function copying a data value from a worksheet or other data field. This is largely due to many different scenarios the current line is designed to cover rarely or never actually take place.

In one embodiment, once candidate functions are generated at GENERATE CANDIDATE FUNCTIONS FOR THE FORM FIELD ACCORDING TO THE DETERMINED PARAMETERS OPERATION 408, process flow proceeds at GENERATE MATCHING DATA FOR CANDIDATE FUNCTIONS OPERATION 410. In one embodiment, this process operation includes one or more operations previously discussed with respect to FIG. 3, including one or more of GENERATE, FOR ONE OR MORE CANDIDATE FUNCTIONS, TEST DATA BY APPLYING THE CANDIDATE FUNCTION TO THE TRAINING SET DATA OPERATION 312 of FIG. 3 and GENERATE, FOR ONE OR MORE CANDIDATE FUNCTIONS, MATCHING DATA INDICATING HOW CLOSELY THE TEST DATA MATCHES CORRESPONDING COMPLETED DATA FIELDS OF THE PREVIOUSLY FILLED FORMS OPERATION 314. In one embodiment, once test data is generated by, for example, substituting a portion of training set data associated with one or more dependencies, that test data is compared against an actual, known correct data value of the training set data associated with the current line associated with the function being learned. An error function may be used to provide an indication of how closely the actual, known correct data value of the training set data matches the test data generated by the candidate function. Continuing the example above where line 2b of the same form as the data field and function being learned and line 12 of a different form are dependencies associated with line 5 of a current form, where a function for line 5 is being learned, each data set of the training set data used to learn an acceptable function includes at least three data values, the values for line 2b and line 5 of the current form and line 12 of a different form. Furthering the example, assume that there are twenty-four such data sets within the training set data. When test data is generated, each of the respective data values for line 2b and line 5 are substituted, if needed, into a given candidate function being considered, resulting in a line 5 result in the test data. Thus, if all twenty-four data sets are used, then there will be twenty-four data values representing the line 5 test data results for the various data sets. Each of those twenty-four data values representing the line 5 within the test data are compared with the respective line 5 data values within the training set data. Some of the twenty-four line 5 data values may match their line 5 counterpart data values within the training set data exactly, while others may match closely, but not exactly, while yet others may not even be close matches.

In one embodiment, at GENERATE MATCHING DATA FOR CANDIDATE FUNCTIONS OPERATION 410 of FIG. 4, the matching data is in the form of a confidence score which includes consideration of how many data values of the test data match their line counterpart data values within the training set data, with points being assigned to a given candidate function based on a percentage of those values that match. In one embodiment, higher numbers of points are assigned for higher percentages of the values matching, reflecting a preference for higher percentages of matches, where candidate functions having higher numbers of points are preferred over candidate functions having lower numbers of points.

In one embodiment, a given candidate function is further assigned an additional points value depending on whether the candidate function uses one or more operators more than once. In one embodiment, higher numbers of points are assigned for functions using operators fewer numbers of times with candidate functions having higher numbers of points being preferred over candidate functions having lower numbers of points.

In one embodiment, a given candidate function is further assigned an additional points value depending on whether the candidate function is shorter than other candidate functions. In one embodiment, higher numbers of points are assigned for shorter functions with candidate functions having higher numbers of points being preferred over candidate functions having lower numbers of points. In one embodiment, a shorter candidate function is a candidate function having a fewer total number of operators present in the candidate function. In one embodiment, a shorter candidate function is a candidate function having a fewer total number of operators and constants present in the candidate function. In one embodiment, a shorter candidate function is a candidate function having a fewer total number of operators and dependencies present in the candidate function.

In one embodiment, a fitness function is used to determine whether one or more candidate functions are acceptable. In one embodiment, the fitness function includes consideration of an error function such as a square root of the sum of the squares of the differences between the desired output of a candidate function and the actual output of the candidate function, for each data set of the training set data, as discussed below. Other considerations included in a fitness function, according to various embodiments, are one or more of how many operators are present in the candidate function, how many operators depend on results of other operators completing prior operations, whether there are missing arguments in the candidate function, and whether an argument is repeated in the candidate function.

Many other types of matching data reflecting the degree of preference of one or more candidate functions over other candidate functions may be developed and used similarly, without departing from the scope and teachings of this disclosure.

It may be desirable, in some situations, to discontinue producing new candidate functions, such as if an error function or a fitness function discussed herein reflects that the fitness, or acceptability, of the entire population is within a predetermined margin, such as if fitness values for each candidate function determined using a fitness function discussed herein are all within 10% of each other, or if a standard deviation of the fitness values is below a certain predetermined value, or using other criteria. Thus, a process operation to test exit conditions is performed at any point during the operation of process 400, using any exit criteria desired by an implementer of process 400. If an exit condition is found to be satisfied, the process exits. In one embodiment, as the process exits, results data is produced reflecting one or more candidate functions. In one embodiment, the one or more candidate functions of the results data includes at least one candidate function which is a better or more acceptable candidate function than at least one other candidate function. In one embodiment, acceptability or a determination of whether one candidate function is better than another candidate function is based on comparing the results of applying a fitness function to test data associated with the candidate functions.

Exit criteria may include a wide variety of conditions. Such conditions include, in various embodiment, a minimum value of an error function associated with the population of candidate functions remaining unchanged within a most recent predetermined number of iterations of process 400, and/or a predefined number of iterations of process 400 have already occurred,

In one embodiment, once matching data has been generated at GENERATE MATCHING DATA FOR CANDIDATE FUNCTIONS OPERATION 410, process flow proceeds at SELECT ONE OR MORE CANDIDATE FUNCTIONS NOT MEETING ACCEPTABILITY CRITERIA OPERATION 412.

In one embodiment, at SELECT ONE OR MORE CANDIDATE FUNCTIONS NOT MEETING ACCEPTABILITY CRITERIA OPERATION 412 there is acceptability criteria that must be met in order for a given candidate function to be determined to be an acceptable candidate function so that learning may be considered to be complete. In one embodiment, using the example provided above where the matching data include points being assigned to a candidate function based on one or more factors such as the length of the function, how many data sets are matched by the test data, etc., the acceptability criteria includes a threshold number of points a given candidate function must have in order to be considered acceptable.

In one embodiment, after having been evaluated at GENERATE MATCHING DATA FOR CANDIDATE FUNCTIONS OPERATION 410, each candidate function has a number of points assigned. In a system, like the examples above, where having a greater number of points is better than having fewer points, a given candidate function is not acceptable if it has fewer than a threshold number of points assigned to it.

In one embodiment, at SELECT ONE OR MORE CANDIDATE FUNCTIONS NOT MEETING ACCEPTABILITY CRITERIA OPERATION 412 any candidate functions not meeting acceptability criteria, such as not having enough points assigned to exceed a threshold number of points, are determined. In one embodiment, only a predetermined number of candidate functions are selected from all of the candidate functions generated at GENERATE CANDIDATE FUNCTIONS FOR THE FORM FIELD ACCORDING TO THE DETERMINED PARAMETERS OPERATION 408. In one embodiment, the predetermined number of candidate functions selected at SELECT ONE OR MORE CANDIDATE FUNCTIONS NOT MEETING ACCEPTABILITY CRITERIA OPERATION 412 are the best candidate functions, as determined by those candidate functions having the highest number of points, or those candidate functions having the lowest error, or using any other criteria known to those of ordinary skill or developed later. In one example, assume two hundred candidate functions were generated at GENERATE CANDIDATE FUNCTIONS FOR THE FORM FIELD ACCORDING TO THE DETERMINED PARAMETERS OPERATION 408. Further assume that none of the candidate functions meet acceptability criteria, such as a point threshold discussed above. In one embodiments, at SELECT ONE OR MORE CANDIDATE FUNCTIONS NOT MEETING ACCEPTABILITY CRITERIA OPERATION 412, a subset of the 200 generated candidate functions are selected for further processing. In one embodiment, the subset includes the best twenty candidate functions selected, based on the matching data of GENERATE MATCHING DATA FOR CANDIDATE FUNCTIONS OPERATION 410.

In one embodiment, tested candidate functions may be grouped into random groups of a predetermined size, and the best one or more candidate functions in each group may also/instead be selected at SELECT ONE OR MORE CANDIDATE FUNCTIONS NOT MEETING ACCEPTABILITY CRITERIA OPERATION 412.

Many other options for selecting candidate functions to be at least partly used in process operations below are possible, with the variation remaining under the scope of this disclosure.

Once one or more candidate functions not meeting acceptability criteria are selected at SELECT ONE OR MORE CANDIDATE FUNCTIONS NOT MEETING ACCEPTABILITY CRITERIA OPERATION 412, process flow proceeds at SPLIT EACH OF THE ONE OR MORE SELECTED CANDIDATE FUNCTIONS INTO COMPONENTS; RECOMBINE THE COMPONENTS INTO NEW CANDIDATE FUNCTIONS OPERATION 414.

In one embodiment, at SPLIT EACH OF THE ONE OR MORE SELECTED CANDIDATE FUNCTIONS INTO COMPONENTS; RECOMBINE THE COMPONENTS INTO NEW CANDIDATE FUNCTIONS OPERATION 414, one or more of the candidate functions selected at SELECT ONE OR MORE CANDIDATE FUNCTIONS NOT MEETING ACCEPTABILITY CRITERIA OPERATION 412 are split into two or more components. One or more of those components are then recombined with other candidate functions, or other components, resulting in new candidate functions.

In one embodiment, one or more candidate functions are split at or near a halfway point, leaving equal or relatively equal numbers of operators in each of the resulting components. In one embodiment, in the case of a candidate function having an odd number of operators, the candidate function is split, resulting in two components, where one of the components has one operators more than the component. In one embodiment, one or more candidate functions are split into three or more components. Further, it is not necessary that each candidate function be split into the same number of components. Finally, one or more components from a first split candidate function may be recombined with components from one, two, three or more other split candidate functions.

If it is desirable in a given implementation to generate additional candidate functions from the original candidate functions, one or more of the original candidate functions are used, in one embodiment, to generate one or more new candidate functions through process 400 randomly replacing one or more portions of the original candidate function. In one embodiment, randomly replacing one or more portions of the original candidate function includes replacing one or more operators and/or constants in the original candidate function with one or more different operators. In one embodiment, the one or more different operators are randomly selected. In one embodiment, the one or more different operators are selected from a group of operators not already present in the original candidate function.

In one embodiment, one or more of the original candidate functions are grouped with or otherwise used in a future fitness evaluation/test cycle with the new candidate functions. Thus, those original candidate functions that are used in a later evaluation/test cycle will also be referred to as new candidate functions just to ensure that one or more operations described herein as being performed on new candidate functions may also be performed on those original candidate functions.

In one embodiment, once new candidate functions are generated at SPLIT EACH OF THE ONE OR MORE SELECTED CANDIDATE FUNCTIONS INTO COMPONENTS; RECOMBINE THE COMPONENTS INTO NEW CANDIDATE FUNCTIONS OPERATION 414, process flow proceeds at IDENTIFY ONE OR MORE CANDIDATE FUNCTIONS THAT MEET ACCEPTABILITY CRITERIA, OR ALTERNATIVELY SPLIT AND RECOMBINE CANDIDATE FUNCTIONS UNTIL ACCEPTABILITY CRITERIA IS SATISFIED OPERATION 416.

In one embodiment, the process flow continues by testing the new candidate functions and identifying, using matching data or otherwise any candidate functions meeting acceptability criteria, any of the new candidate functions that are acceptable. If no candidate functions found to be acceptable, process flow repeats the splitting, recombining, and testing operations until one or more acceptable candidate functions are found. Following one or more acceptable candidate functions being found, process flow proceeds at GENERATE RESULTS DATA INDICATING ONE OR MORE ACCEPTABLE CANDIDATE FUNCTIONS OPERATION 418.

In one embodiment, at GENERATE RESULTS DATA INDICATING ONE OR MORE ACCEPTABLE CANDIDATE FUNCTIONS OPERATION 418, results data is generated indicating one or more acceptable functions. If more than one acceptable function has been found, the results data may optionally include more than one of the acceptable functions.

In one embodiment, process flow then proceeds to OUTPUT THE RESULTS DATA OPERATION 420.

In one embodiment, at OUTPUT THE RESULTS DATA OPERATION 420 the results data are provided to one or more users of the process as discussed herein after which process flow proceeds to END OPERATION 422.

In one embodiment, at END OPERATION 422 the process for learning and incorporating new and/or updated forms in an electronic document preparation system is exited to await new data and/or instructions.

In the discussion above, reference was made to the natural language parsing module 115 analyzing the form data 119 with a natural language parsing process. The disclosure below teaches an additional embodiment of the natural language parsing process.

In discussions above, natural language processing is one of several inputs into various processes to determine and incorporate one or more functions into a document processing system, where the incorporated function or functions relate to one or more form field values that need to be determined in order to complete a given form.

In particular, natural language processing is used, in one embodiment, to determine one or more operators to be used in a function that is later to be associated with a given line of a form having a form field of interest. Further, natural language processing is used, in one embodiment, to determine one or more dependencies associated with a given line of a form having a form field of interest.

In one embodiment, dependencies for a given data field of the new and/or updated form includes references to data values from one or more other data fields of the new and/or updated form. In one embodiment, the dependencies for a given data field of the new and/or updated form includes references to data values from other data fields of one or more other old, new, or updated forms, worksheets, or data values from other locations internal or external to the electronic document preparation system. In one embodiment, the dependencies include one or more constants.

In addition to possibly including one or more dependencies, in one embodiment, a final function for a given data field of the new and/or updated form includes one or more operators that operate on one or more of the dependencies in a particular manner. The operators include, in various embodiments, arithmetic operators such as addition, subtraction, multiplication, division or other mathematical operators such as exponential functions and logical operators such as if-then and/or if-then-else operators, and/or Boolean operators such as true/false. The operators can include also existence condition operators that depend on the existence of a data value in another data field of new and/or updated form, in a form other than the new and/or updated form, or in some other location or data set. The operators can include string comparisons and/or rounding or truncating operations.

More particularly, embodiments include a computing system implemented method for learning and incorporating forms in an electronic document preparation system including receiving electronic textual data including instructions to determine one or more form field values of one or more forms of the plurality of forms. The method further includes, in one embodiment, analyzing the electronic textual data to determine sentence data representing separate sentences of the electronic textual data, and separating the electronic textual data into the determined separate sentences. Further, in one embodiment, for each sentence, extracting, for each given sentence of sentence data representing sentences in the data array, operand data representing one or more extracted operands of the sentence, and determining sentence fragment data for parts of speech for sentence fragments of the sentence including sentence fragment data representing word groups forming one or more parts of speech. Then, in one embodiment, separating sentence fragment data of the sentence containing verbs and sentence fragment data containing “if” or “minus” where the associated part of speech is either a prepositional phrase or a clause introduced by a subordinating conjunction, resulting in separated sentence fragment data.

Further, in one embodiment, for each token present in sentence data, removing any word present in exclusion data, filtering the sentence data to keep only tokens meeting at least one token test, and combining the filtered token data and the separated sentence fragment data and eliminating sentence fragments containing words from the exclusion data representing a predetermined exclusion list, resulting in filtered sentence fragment data. Finally, in one embodiment, replacing, within sentences of the data array, all single-word sentence fragments of the filtered sentence fragment data having similar meanings with a single word and extracting text-readable functions from sentences of the data array by matching predetermined patterns and replacing matched patterns with function data representing text-readable functions, converting the function data to computer readable functions, and implementing one or more of the computer readable functions in a document preparation system such as a tax preparation system. Additional details relating to process operations of a computing system implemented method for learning and incorporating forms in an electronic document preparation system will be discussed below.

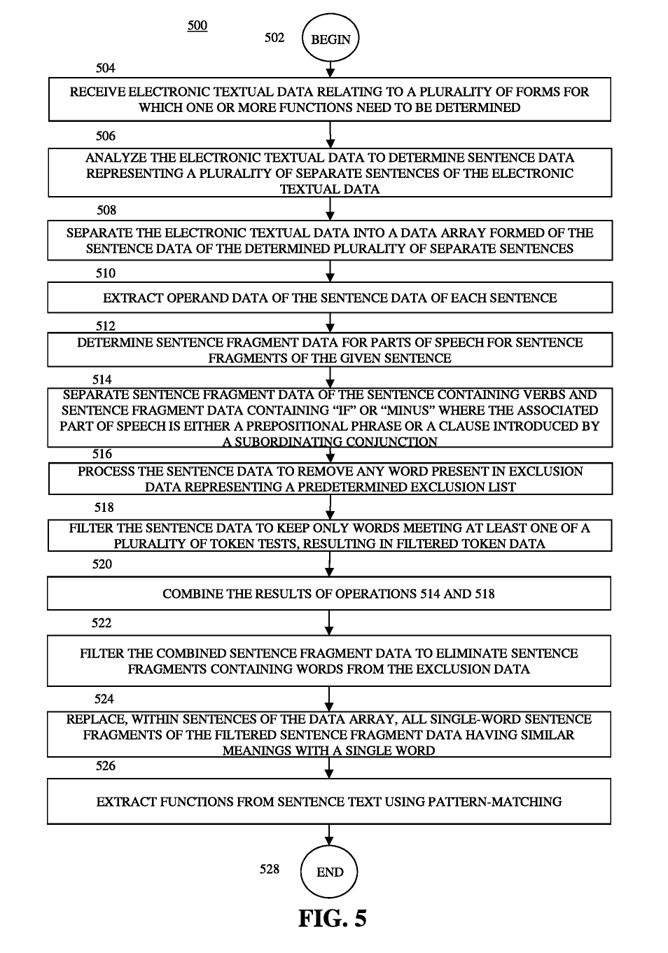

FIG. 5 is a flow diagram of a process for learning and incorporating new and/or updated forms in an electronic document preparation system, in accordance with one embodiment.

Referring to FIG. 1 and FIG. 5 together, process 500 for learning and incorporating new and/or updated forms in an electronic document preparation system starts with BEGIN OPERATION 502 and process flow proceeds with RECEIVE ELECTRONIC TEXTUAL DATA RELATING TO A PLURALITY OF FORMS FOR WHICH ONE OR MORE FUNCTIONS NEED TO BE DETERMINED OPERATION 504.

In one embodiment, at RECEIVE ELECTRONIC TEXTUAL DATA RELATING TO A PLURALITY OF FORMS FOR WHICH ONE OR MORE FUNCTIONS NEED TO BE DETERMINED OPERATION 504, interface module 112 is configured to receive form data 119 related to a new and/or updated form. Interface module 112 can receive the form data 119 from an expert, from a government agency, from a financial institution, or in other ways now known or later developed. In various embodiments, form data 119 originates as one or more physical printed pages or electronic equivalents of actual form data relating to the physical form, such as an instruction booklet or other documentation, to electronic textual data. For example, the form data 119 may include text descriptions and/or form text for various data fields of the new and/or updated form. The text descriptions and form text originate from one or more different sources, such as, in the case of the new and/or updated U.S. tax form, from the Internal Revenue Service (IRS). The text descriptions and form text include, in one embodiment, text of one or more actual tax forms issued by the IRS and required to be filled out by taxpayers for which the new and/or updated form applies. The text descriptions and form text further include, in one embodiment, text of one or more instruction sets and publications issued by the IRS to assist the tax payer or tax preparer properly complete the form. The natural language parsing module 115 analyzes, in one embodiment, these text descriptions through process described herein and generates natural language parsing data 118 indicating the type of data value expected in each data field, among other things.

In one embodiment, form data 119 relates to specific subsections of a given new or updated form, such as form text and/or form data of or relating to one or more form fields of the new or updated form, such as changed sections of the form from a prior version. In one embodiment, at RECEIVE ELECTRONIC TEXTUAL DATA RELATING TO A PLURALITY OF FORMS FOR WHICH ONE OR MORE FUNCTIONS NEED TO BE DETERMINED OPERATION 504, form data 119 originates as one or more portions or components of physical forms such as paper forms which are scanned or otherwise converted through optical character recognition or other known or later developed methods from physical form to electronic textual data of form data 119. In one embodiment, the electronic textual data relating to portions of or the entirety of the new or updated form is collected into an electronic text corpus including all of the acquired and converted text data and stored as at least a portion of form data 119.

In one embodiment, following completion of RECEIVE ELECTRONIC TEXTUAL DATA RELATING TO A PLURALITY OF FORMS FOR WHICH ONE OR MORE FUNCTIONS NEED TO BE DETERMINED OPERATION 504, process flow proceeds with ANALYZE THE ELECTRONIC TEXTUAL DATA TO DETERMINE SENTENCE DATA REPRESENTING A PLURALITY OF SEPARATE SENTENCES OF THE ELECTRONIC TEXTUAL DATA OPERATION 506.

In one embodiment, at ANALYZE THE ELECTRONIC TEXTUAL DATA TO DETERMINE SENTENCE DATA REPRESENTING A PLURALITY OF SEPARATE SENTENCES OF THE ELECTRONIC TEXTUAL DATA OPERATION 506, the electronic text corpus of form data 119 formed at RECEIVE ELECTRONIC TEXTUAL DATA RELATING TO A PLURALITY OF FORMS FOR WHICH ONE OR MORE FUNCTIONS NEED TO BE DETERMINED OPERATION 504 is analyzed to determine individual sentences of the electronic text corpus and to separate sentence data representing those individual sentences into a data array whose array members are the individual sentences of the electronic text corpus. In one embodiment, the sentences of the electronic text corpus are not formed as individual members of a data array, but rather are processed individually, thus processing sentence data representing each individual sentence according to one or more of the process operations discussed herein.

In one embodiment, following the electronic text corpus of RECEIVE ELECTRONIC TEXTUAL DATA RELATING TO A PLURALITY OF FORMS FOR WHICH ONE OR MORE FUNCTIONS NEED TO BE DETERMINED OPERATION 504 being analyzed and separated into sentences at ANALYZE THE ELECTRONIC TEXTUAL DATA TO DETERMINE SENTENCE DATA REPRESENTING A PLURALITY OF SEPARATE SENTENCES OF THE ELECTRONIC TEXTUAL DATA OPERATION 506, process flow proceeds with SEPARATE THE ELECTRONIC TEXTUAL DATA INTO A DATA ARRAY FORMED OF THE SENTENCE DATA OF THE DETERMINED PLURALITY OF SEPARATE SENTENCES OPERATION 508 where the electronic textual data analyzed at ANALYZE THE ELECTRONIC TEXTUAL DATA TO DETERMINE SENTENCE DATA REPRESENTING A PLURALITY OF SEPARATE SENTENCES OF THE ELECTRONIC TEXTUAL DATA OPERATION 506 is separated into a data array formed of individual sentence data items, each data item of the data array representing a different sentence of the text corpus. In one embodiment, following the electronic textual data being separated into a data array formed of individual sentence data items, each data item of the data array representing a different sentence of the text corpus at SEPARATE THE ELECTRONIC TEXTUAL DATA INTO A DATA ARRAY FORMED OF THE SENTENCE DATA OF THE DETERMINED PLURALITY OF SEPARATE SENTENCES OPERATION 508, process flow proceeds with EXTRACT OPERAND DATA OF THE SENTENCE DATA OF EACH SENTENCE OPERATION 510.

In one embodiment, at EXTRACT OPERAND DATA OF THE SENTENCE DATA OF EACH SENTENCE OPERATION 510, operand data is extracted from each sentence being processed, and tracked so that extracted operands are attributed or otherwise tagged as having originated in a particular sentence.

In one embodiment, an operand is a sentence fragment that is operated on by an operator. Operators can include arithmetic operators such as addition, subtraction, multiplication, or division operators; logical operators such as if-then operators; existence condition operators that depend on the existence of a dependency such as a data value in another data field of new and/or updated form, in a form other than the new and/or updated form, or in some other location or data set; and string comparisons including greater than, less than and equal to, among others.

For example, if a sentence being analyzed is “combine line 1 of form 2441 with line 6 of form 2441, the operator is “combine” and the operand s, which are also dependencies, are “line 1 form 2441” and “line 6 form 2441.” In one embodiment, an operator is a verb, and operates on a dependency or constant. As explained herein, dependencies can include one or more data values from other data fields of the new and/or updated form, one or more data values from another related form or worksheet, one or more constants, or many other kinds of possible dependencies that can be included in an acceptable function for a particular data field.

In one embodiment, following operand data of the sentence data for each sentence of the data array being extracted, or alternatively following the extraction of operands of individual sentences being processed one at a time according to ANALYZE THE ELECTRONIC TEXTUAL DATA TO DETERMINE SENTENCE DATA REPRESENTING A PLURALITY OF SEPARATE SENTENCES OF THE ELECTRONIC TEXTUAL DATA OPERATION 506, process flow proceeds with DETERMINE SENTENCE FRAGMENT DATA FOR PARTS OF SPEECH FOR SENTENCE FRAGMENTS OF THE GIVEN SENTENCE OPERATION 512.

In one embodiment, at DETERMINE SENTENCE FRAGMENT DATA FOR PARTS OF SPEECH FOR SENTENCE FRAGMENTS OF THE GIVEN SENTENCE OPERATION 512, for each sentence being processed, the sentence is analyzed and different parts of speech are identified. Optionally, short phrases are also identified, in one embodiment. Parts of speech data representing which part of speech was identified and which words of the sentence forms that part of speech are tracked and stored in sentence fragment data. One or more of nouns, verbs, prepositional phrases, subordinating conjunctions, or any other parts of speech now known or later developed are parts of speech that may be identified herein, in various embodiments.

In one embodiment, following the analysis of sentences being processed to identify parts of speech and store data regarding which parts of speech were identified and which sentence fragments are associated with those stored parts of speech at DETERMINE SENTENCE FRAGMENT DATA FOR PARTS OF SPEECH FOR SENTENCE FRAGMENTS OF THE GIVEN SENTENCE OPERATION 512, process flow proceeds with SEPARATE SENTENCE FRAGMENT DATA OF THE SENTENCE CONTAINING VERBS AND SENTENCE FRAGMENT DATA CONTAINING “IF” OR “MINUS” WHERE THE ASSOCIATED PART OF SPEECH IS EITHER A PREPOSITIONAL PHRASE OR A CLAUSE INTRODUCED BY A SUBORDINATING CONJUNCTION OPERATION 514.

In one embodiment, at SEPARATE SENTENCE FRAGMENT DATA OF THE SENTENCE CONTAINING VERBS AND SENTENCE FRAGMENT DATA CONTAINING “IF” OR “MINUS” WHERE THE ASSOCIATED PART OF SPEECH IS EITHER A PREPOSITIONAL PHRASE OR A CLAUSE INTRODUCED BY A SUBORDINATING CONJUNCTION OPERATION 514, sentence fragment data of DETERMINE SENTENCE FRAGMENT DATA FOR PARTS OF SPEECH FOR SENTENCE FRAGMENTS OF THE GIVEN SENTENCE OPERATION 512 is analyzed according to the previously determined parts of speech associated with various portions of the sentence being processed, and sentence fragment data that contain verbs are isolated from the remainder of the sentence fragments not containing verbs. Further, in one embodiment, the remainder of the sentence fragment data, e.g. sentence fragment data representing sentence fragments not containing verbs, are further analyzed to determine whether the remainder of the sentence fragment data includes one or more sentence fragments contain “if” or “minus” and have an associated part of speech that has been identified as a prepositional phrase or a clause introduced by a subordinating conjunction. If a determination is made that one or more sentence fragments contain “if” or “minus” and have an associated part of speech that has been identified as a prepositional phrase or a clause introduced by a subordinating conjunction, sentence fragments data representing those sentence fragments are combined with the sentence fragment data that contain verbs, resulting in final sentence fragment data. In one embodiment, sentence fragment data that is not a part of final sentence fragment data is discarded.

In one example, in a sentence “Do not enter more than $5000,” sentence fragments “Do not enter” and “more than $5000” would be identified. Since “enter” is a verb, the sentence fragment “Do not enter” would be kept, while the remaining sentence fragment “more than $5000” would be discarded or otherwise not used in further processing operations.

In one embodiment, a first set of process operations to determine a set of operators present in a given sentence has been described above, and a second set of operations to determine a set of operators present in a given sentence is described below. Results from the two different sets of operations will be combined and processed further to determine a final set of operators.

In one embodiment, following completion of the analysis according to the previously determined parts of speech associated with various portions of the sentence being processed, and the separation of sentence fragment data that contain verbs from the remainder of the sentence fragments not containing verbs and the isolation of the remainder of the sentence fragment data including one or more sentence fragments contain “if” or “minus” and have an associated part of speech that has been identified as a prepositional phrase or a clause introduced by a subordinating conjunction at SEPARATE SENTENCE FRAGMENT DATA OF THE SENTENCE CONTAINING VERBS AND SENTENCE FRAGMENT DATA CONTAINING “IF” OR “MINUS” WHERE THE ASSOCIATED PART OF SPEECH IS EITHER A PREPOSITIONAL PHRASE OR A CLAUSE INTRODUCED BY A SUBORDINATING CONJUNCTION OPERATION 514, process flow proceeds with PROCESS THE SENTENCE DATA TO REMOVE ANY WORD PRESENT IN EXCLUSION DATA REPRESENTING A PREDETERMINED EXCLUSION LIST OPERATION 516.

In one embodiment, at PROCESS THE SENTENCE DATA TO REMOVE ANY WORD PRESENT IN EXCLUSION DATA REPRESENTING A PREDETERMINED EXCLUSION LIST OPERATION 516, sentence data of SEPARATE THE ELECTRONIC TEXTUAL DATA INTO A DATA ARRAY FORMED OF THE SENTENCE DATA OF THE DETERMINED PLURALITY OF SEPARATE SENTENCES OPERATION 508 is analyzed and processed to remove any words found on an exclusion list. In one embodiment, the exclusion list is predetermined and contains inconsequential or less important words according to the genre of the text corpus. In one embodiment, the exclusion list is prepared by a third party and retrieved by electronic document preparation system 111.

In one embodiment, following processing of the sentence data of SEPARATE THE ELECTRONIC TEXTUAL DATA INTO A DATA ARRAY FORMED OF THE SENTENCE DATA OF THE DETERMINED PLURALITY OF SEPARATE SENTENCES OPERATION 508 at PROCESS THE SENTENCE DATA TO REMOVE ANY WORD PRESENT IN EXCLUSION DATA REPRESENTING A PREDETERMINED EXCLUSION LIST OPERATION 516, process flow proceeds with FILTER THE SENTENCE DATA TO KEEP ONLY WORDS MEETING AT LEAST ONE OF A PLURALITY OF TOKEN TESTS, RESULTING IN FILTERED TOKEN DATA OPERATION 518.

In one embodiment, at FILTER THE SENTENCE DATA TO KEEP ONLY WORDS MEETING AT LEAST ONE OF A PLURALITY OF TOKEN TESTS, RESULTING IN FILTERED TOKEN DATA OPERATION 518, the results of PROCESS THE SENTENCE DATA TO REMOVE ANY WORD PRESENT IN EXCLUSION DATA REPRESENTING A PREDETERMINED EXCLUSION LIST OPERATION 516 are further processed to discard or otherwise remove from further processing any sentence data that fails a series of token tests, thus keeping all words of the sentence data of PROCESS THE SENTENCE DATA TO REMOVE ANY WORD PRESENT IN EXCLUSION DATA REPRESENTING A PREDETERMINED EXCLUSION LIST OPERATION 516 that meet at least one of the token tests.

In one embodiment, the token tests of FILTER THE SENTENCE DATA TO KEEP ONLY WORDS MEETING AT LEAST ONE OF A PLURALITY OF TOKEN TESTS, RESULTING IN FILTERED TOKEN DATA OPERATION 518 include determining a part of speech of each word of the sentence being processed to determine whether the word is a verb. If the word is a verb, it is marked as satisfying at least one of the token tests, and is thus kept for further processing.

In one embodiment, the token tests of FILTER THE SENTENCE DATA TO KEEP ONLY WORDS MEETING AT LEAST ONE OF A PLURALITY OF TOKEN TESTS, RESULTING IN FILTERED TOKEN DATA OPERATION 518 include determining a part of speech of each word of the sentence being processed to determine whether the word is an adjective superlative. If the word is an adjective superlative, it is marked as satisfying at least one of the token tests, and is thus kept for further processing.

In one embodiment, the token tests of FILTER THE SENTENCE DATA TO KEEP ONLY WORDS MEETING AT LEAST ONE OF A PLURALITY OF TOKEN TESTS, RESULTING IN FILTERED TOKEN DATA OPERATION 518 include determining a part of speech of each word of the sentence being processed to determine whether the word is an adjective comparative. If the word is an adjective comparative, it is marked as satisfying at least one of the token tests, and is thus kept for further processing.

In one embodiment, the token tests of FILTER THE SENTENCE DATA TO KEEP ONLY WORDS MEETING AT LEAST ONE OF A PLURALITY OF TOKEN TESTS, RESULTING IN FILTERED TOKEN DATA OPERATION 518 include determining whether the word being considered is “divide” and whether a part of speech of the word being considered is a noun. If the word being considered is “divide” and its part of speech is noun, the word is marked as satisfying at least one of the token tests, and is thus kept for further processing.

In one embodiment, the token tests of FILTER THE SENTENCE DATA TO KEEP ONLY WORDS MEETING AT LEAST ONE OF A PLURALITY OF TOKEN TESTS, RESULTING IN FILTERED TOKEN DATA OPERATION 518 include determining whether the word being considered is not within final sentence fragment data of SEPARATE SENTENCE FRAGMENT DATA OF THE SENTENCE CONTAINING VERBS AND SENTENCE FRAGMENT DATA CONTAINING “IF” OR “MINUS” WHERE THE ASSOCIATED PART OF SPEECH IS EITHER A PREPOSITIONAL PHRASE OR A CLAUSE INTRODUCED BY A SUBORDINATING CONJUNCTION OPERATION 514. If the word being considered is within any sentence fragment of SEPARATE SENTENCE FRAGMENT DATA OF THE SENTENCE CONTAINING VERBS AND SENTENCE FRAGMENT DATA CONTAINING “IF” OR “MINUS” WHERE THE ASSOCIATED PART OF SPEECH IS EITHER A PREPOSITIONAL PHRASE OR A CLAUSE INTRODUCED BY A SUBORDINATING CONJUNCTION OPERATION 514, the word is discarded for this step, but still remains within the final fragment data.

In one embodiment, following the filtering of sentence data to keep only words meeting one or more token tests at FILTER THE SENTENCE DATA TO KEEP ONLY WORDS MEETING AT LEAST ONE OF A PLURALITY OF TOKEN TESTS, RESULTING IN FILTERED TOKEN DATA OPERATION 518, process flow proceeds with COMBINE THE RESULTS OF OPERATIONS 514 AND 518 OPERATION 520.

In one embodiment, at COMBINE THE RESULTS OF OPERATIONS 514 AND 518 OPERATION 520, the final sentence fragment data resulting from the performance of SEPARATE SENTENCE FRAGMENT DATA OF THE SENTENCE CONTAINING VERBS AND SENTENCE FRAGMENT DATA CONTAINING “IF” OR “MINUS” WHERE THE ASSOCIATED PART OF SPEECH IS EITHER A PREPOSITIONAL PHRASE OR A CLAUSE INTRODUCED BY A SUBORDINATING CONJUNCTION OPERATION 514 is combined with the final fragment data resulting from the performance of FILTER THE SENTENCE DATA TO KEEP ONLY WORDS MEETING AT LEAST ONE OF A PLURALITY OF TOKEN TESTS, RESULTING IN FILTERED TOKEN DATA OPERATION 518.

In one embodiment, following combining the results of the process operations SEPARATE SENTENCE FRAGMENT DATA OF THE SENTENCE CONTAINING VERBS AND SENTENCE FRAGMENT DATA CONTAINING “IF” OR “MINUS” WHERE THE ASSOCIATED PART OF SPEECH IS EITHER A PREPOSITIONAL PHRASE OR A CLAUSE INTRODUCED BY A SUBORDINATING CONJUNCTION OPERATION 514 and FILTER THE SENTENCE DATA TO KEEP ONLY WORDS MEETING AT LEAST ONE OF A PLURALITY OF TOKEN TESTS, RESULTING IN FILTERED TOKEN DATA OPERATION 518, process flow proceeds with FILTER THE COMBINED SENTENCE FRAGMENT DATA TO ELIMINATE SENTENCE FRAGMENTS CONTAINING WORDS FROM THE EXCLUSION DATA 522. In one embodiment, FILTER THE COMBINED SENTENCE FRAGMENT DATA TO ELIMINATE SENTENCE FRAGMENTS CONTAINING WORDS FROM THE EXCLUSION DATA 522 may be performed instead of PROCESS THE SENTENCE DATA TO REMOVE ANY WORD PRESENT IN EXCLUSION DATA REPRESENTING A PREDETERMINED EXCLUSION LIST OPERATION 516 because FILTER THE COMBINED SENTENCE FRAGMENT DATA TO ELIMINATE SENTENCE FRAGMENTS CONTAINING WORDS FROM THE EXCLUSION DATA 522 is performed on the combined results of two different prior operations. However, processing sentence data to exclude sentence fragment data that appears on an exclusion list may be performed at any time, or multiple times, depending on circumstances, so long as when it is performed and the sentence fragment data that results doesn't have any words or phrases of the exclusion list present.

In one embodiment, following the exclusion of words of the exclusion list from the combined results, process flow proceeds with REPLACE, WITHIN SENTENCES OF THE DATA ARRAY, ALL SINGLE-WORD SENTENCE FRAGMENTS OF THE FILTERED SENTENCE FRAGMENT DATA HAVING SIMILAR MEANINGS WITH A SINGLE WORD OPERATION 524.

In one embodiment, at REPLACE, WITHIN SENTENCES OF THE DATA ARRAY, SINGLE-WORD SENTENCE FRAGMENTS OF THE FILTERED SENTENCE FRAGMENT DATA HAVING SIMILAR MEANINGS WITH A SINGLE WORD OPERATION 524, synonyms of operators in the original data array of sentences are replaced with a common word, thus simplifying the vocabulary in use.

For example, “add” and “combine” are both synonyms and “combine” is thus replaced, in one embodiment, with a one word synonym “add.” Correspondingly, in one embodiment, “smaller,” lowest,”, and “minimum” are all synonyms, and “smaller” and “lowest” are replaced with “minimum.” It could just as easily been “lower” and “minimum” being replaced with “smaller,” or “smaller” and “minimum” being replaced with “lowest.”

In one embodiment, following the completion of REPLACE, WITHIN SENTENCES OF THE DATA ARRAY, SINGLE-WORD SENTENCE FRAGMENTS OF THE FILTERED SENTENCE FRAGMENT DATA HAVING SIMILAR MEANINGS WITH A SINGLE WORD OPERATION 524, process flow proceeds with EXTRACT FUNCTIONS FROM SENTENCE TEXT USING PATTERN-MATCHING OPERATION 526.

In one embodiment, at EXTRACT FUNCTIONS FROM SENTENCE TEXT USING PATTERN-MATCHING OPERATION 526, the results of REPLACE, WITHIN SENTENCES OF THE DATA ARRAY, SINGLE-WORD SENTENCE FRAGMENTS OF THE FILTERED SENTENCE FRAGMENT DATA HAVING SIMILAR MEANINGS WITH A SINGLE WORD OPERATION 524 are processed through a pattern-matching algorithm where the sentence text having common operators are examined to determine whether the sentence text matches a predetermined pattern, and if so, replacing the format of the sentence text with a predetermined matching function.

In an example which combines REPLACE, WITHIN SENTENCES OF THE DATA ARRAY, SINGLE-WORD SENTENCE FRAGMENTS OF THE FILTERED SENTENCE FRAGMENT DATA HAVING SIMILAR MEANINGS WITH A SINGLE WORD OPERATION 524 and EXTRACT FUNCTIONS FROM SENTENCE TEXT USING PATTERN-MATCHING OPERATION 526, the results of REPLACE, WITHIN SENTENCES OF THE DATA ARRAY, SINGLE-WORD SENTENCE FRAGMENTS OF THE FILTERED SENTENCE FRAGMENT DATA HAVING SIMILAR MEANINGS WITH A SINGLE WORD OPERATION 524, if the sentence text being analyzed is “combine line 1 of form 2441 with line 3 of form 2441. In this example, dependencies would have previously been determined to be “line 1 of form 2441” and “line 3 of form 2441.” The word “with would have been removed, perhaps as being on the exclusion list, or by not passing the token tests. The word “combine” is an operator, e.g. it operates on one or more dependencies or other operands, and would possible be replaced, at REPLACE, WITHIN SENTENCES OF THE DATA ARRAY, SINGLE-WORD SENTENCE FRAGMENTS OF THE FILTERED SENTENCE FRAGMENT DATA HAVING SIMILAR MEANINGS WITH A SINGLE WORD OPERATION 524 with “add,” resulting in the sentence now reading “add” “line 1 of form 2441” “line 3 of form 2441.” At EXTRACT FUNCTIONS FROM SENTENCE TEXT USING PATTERN-MATCHING OPERATION 526, an exemplary pattern is, in one embodiment, “add”[dependency1] [dependency2] which would match “add” “line 1 of form 2441” and “line 3 of form 2441.” Once the pattern is matched, the sentence text is replaced with a computer-executable function for the form field value, where the computer executable function represents the human-readable equation “line 1 of form 2441”+“line 3 of form 2441.

In one embodiment, at, or prior to, EXTRACT FUNCTIONS FROM SENTENCE TEXT USING PATTERN-MATCHING OPERATION 526, patterns are developed through a process which includes an analysis of the text corpus.

In one embodiment, a determination is made as to sentence structure of lines of the text corpus that include operators and which therefore also likely need to be converted to computer executable functions.

In one embodiment, structure descriptors are defined, and equivalents to each structure descriptor are defined. For example, a structure descriptor “operator_key” is defined, and add, subtract, multiply, and divide are members of a set of operators associated with that structure descriptor.

In various embodiments, structure descriptors are defined, and one or more of “constant_key,” which designates that a known constant is being used, “logical_key,” which designates that a known logical operator is being used, “delimiter key,” which indicates the presence of punctuation, and “number” which indicates the presence of a number, are employed.

A useful notation to use when employing the process operations discussed herein is

Structure descriptor (key1, key2, key3, key4 . . . ) where key1, key2, key3, and key4 are tokens/words symbols expressed in the corpus that meet the definition of the particular structure descriptor.

In various embodiments, using the notation above, the structure descriptors and associated keys include one or more of

operator_key (add, subtract, multiply, divide)

constant_key (line, lines, ln)

number (1, 2, 3, 4, 5, 6, 7, 8, 9, 0)

logical_key (and, or, from, by) and

delimeter key (. \, , \) where the punctuation item is offset by a forward slash.

An optional next process operation in determining patterns to be converted to executable/machine code is to determine a frequency of patterns appearing in the text corpus. In one embodiment, patterns are determined for each line of the text corpus that is associated with a form field value of a form in the document preparation system. In one embodiment, patterns are determined only for a subset of lines of the text corpus having sentence structures that appear with a frequency that exceeds a predetermined threshold.

In one embodiment, a sentence structure is determined by mapping and replacing each key in the line or sentence, for example, with the appropriate structure designator. In one example, using the structure designators defined above and using the keys associated with each of the structure designators shown above, a line of the text corpus that has been processed to remove words on an exclusion list, such as is done at PROCESS THE SENTENCE DATA TO REMOVE ANY WORD PRESENT IN EXCLUSION DATA REPRESENTING A PREDETERMINED EXCLUSION LIST OPERATION 516, appears as

add line 1 and line 2

(where line 1 and line 2 are form field values of the form being processed). Since “add” appears as being associated with the structure designator “operator_key,” that key is replaced with “operator_key.” Correspondingly, “line” appears as a key of the structure designator “constant_key,” and thus is replaced with “constant_key.” The remaining terms/keys of the line are correspondingly replaced with the associated structure designators, thus resulting on a new pattern construct

operator_key constant_key number logical_key constant_key number

which represents the pattern construct of the line “add line 1 and line 2.” Note, for example, that in our example, the structure designator “operator_key” includes keys “add,” “subtract,” “multiply,” and “divide.” It follows, therefore, that

the lines “add line 1 and line 2,” “subtract line 1 from line 2” “multiply line 1 and line 2” “divide line 1 by line 2” will all have the same pattern construct “operator_key constant_key number logical_key constant_key number.”

In one embodiment, once all pattern constructs for all lines of a form being processed that have field values associated therewith are determined, a frequency of appearance of each pattern construct is determined, and the pattern constructs appearing with a frequency greater than a predetermined threshold are identified and marked or otherwise isolated or set aside for pattern generation.

In one embodiment, after sorting the pattern constructs by frequency of appearance, only the top thirty pattern constructs are marked or otherwise isolated or set aside for pattern generation. In one embodiment, after sorting the pattern constructs by frequency of appearance, only the top ten percent of highest frequency pattern constructs are marked or otherwise isolated or set aside for pattern generation. Other thresholds will be obviously to those of ordinary skill, and well within the teachings of the process operations described herein.

In one embodiment, patterns are developed for each of the highest frequency pattern constructs, and are then formed as rules for converting various lines of the text corpus into an intermediate form that can then be converted into computer executable instructions representing functionality that performs the operations specified in the line, e.g. add lines 1 and 2.

Using a rule similar to

```
          {
          ruleType: “tokens”,
          pattern: ( (/add/ || /combine/) /lines/ (/(.)/ || /(\d+)/ || /(\d+.)/ )
/and/ (/(.)/ || /(\d+)/ || /(\d+.)/ )),
          result: (“LINE”,$0[2],“AND”,“LINE”,$0[4])
          }
```

for example, a processed line reading “add lines 1 and 2” would be matched by the pattern and converted thereby to an intermediate functional form
add(line1, line2)

which can then be mapped to a computing processor executable function of the same form. Note that the pattern also matches a line reciting “combine lines [x] and [y]” where X and y are the numbers of the lines to be added or otherwise combined.

Persons of ordinary skill in the art will readily appreciate that many different patterns may be developed which map to functional forms which can then be mapped to computing processor executable functions.

In one embodiment, following the extraction of functions from sentence text through pattern-matching at EXTRACT FUNCTIONS FROM SENTENCE TEXT USING PATTERN-MATCHING OPERATION 526, the extracted function may be tested as discussed herein and then incorporated into the electronic document preparation system using process operations described herein, assuming that the function passes the tests or is otherwise deemed the best function developed for a given form field, as compared with functions determined using other methods discussed herein. In one embodiment, following the extraction of functions from sentence text through pattern-matching at EXTRACT FUNCTIONS FROM SENTENCE TEXT USING PATTERN-MATCHING OPERATION 526, process flow proceeds with END OPERATION 528 where the process ends awaiting further input.

As noted above, the specific illustrative examples discussed above are but illustrative examples of implementations of embodiments of a computing system implemented method for learning and incorporating forms in an electronic document preparation system. Persons of skill in the art will readily recognize that other implementations and embodiments are possible. Therefore, the discussion above should not be construed as a limitation on the claims provided herein.

In one embodiment, a computing system implements a method for learning and incorporating new and/or updated forms in an electronic document preparation system. The method includes receiving electronic textual data including instructions to determine one or more form field values of one or more forms of the plurality of forms. The method further includes, in one embodiment, analyzing the electronic textual data to determine sentence data representing separate sentences of the electronic textual data, and separating the electronic textual data into the determined separate sentences. Further, in one embodiment, for each sentence, extracting, for each given sentence of sentence data representing sentences in the data array, operand data representing one or more extracted operands of the sentence, and determining sentence fragment data for parts of speech for sentence fragments of the sentence including sentence fragment data representing word groups forming one or more parts of speech. Then, in one embodiment, separating sentence fragment data of the sentence containing verbs and sentence fragment data containing “if” or “minus” where the associated part of speech is either a prepositional phrase or a clause introduced by a subordinating conjunction, resulting in separated sentence fragment data.

Further, in one embodiment, for each token present in sentence data, removing any word present in exclusion data, filtering the sentence data to keep only tokens meeting at least one token test, and combining the filtered token data and the separated sentence fragment data and eliminating sentence fragments containing words from the exclusion data representing a predetermined exclusion list, resulting in filtered sentence fragment data. Finally, in one embodiment, replacing, within sentences of the data array, all single-word sentence fragments of the filtered sentence fragment data having similar meanings with a single word and extracting text-readable functions from sentences of the data array by matching predetermined patterns and replacing matched patterns with function data representing text-readable functions, converting the function data to computer readable functions, and implementing one or more of the computer readable functions in a document preparation system such as a tax preparation system.

In one embodiment, a non-transitory computer-readable medium has a plurality of computer-executable instructions which, when executed by a processor, perform a method for learning and incorporating new and/or updated forms in an electronic document preparation system as described herein.

One embodiment is a computing system implemented method for learning and incorporating new and/or updated forms in an electronic document preparation system. The method includes receiving form data related to a new and/or updated form having a plurality of data fields, gathering training set data related to previously filled forms. Each previously filled form has completed data fields that each correspond to a respective data field of the new and/or updated form. The method also includes generating, for a first selected data field of the plurality of data fields of the new and/or updated form, dependency data indicating one or more possible dependencies for an acceptable function that provides a proper data value for the first selected data field. The method further includes generating, for the first selected data field, candidate function data including a plurality of candidate functions based on the dependency data and one or more operators selected from a library of operators, generating, for each candidate function, test data by applying the candidate function to the training set data, and generating, for each candidate function, matching data by comparing the test data to the completed data fields corresponding to the first selected data field, the matching data indicating how closely the test data matches the corresponding completed data fields of the previously filled forms. The method also includes identifying, from the plurality of functions, an acceptable candidate function for the first selected data field of the new and/or updated form by determining, for each candidate function, whether or not the candidate function is an acceptable function for the first selected data field of the new and/or updated form based on the matching data, generating, after identifying an acceptable function for the first data field, results data indicating an acceptable for the first data field of the new and/or updated form, and outputting the results data.

One embodiment is a system for learning and incorporating new and/or updated forms in an electronic document preparation system. The system includes at least one processor at least one memory coupled to the at least one processor. The at least one memory has stored therein instructions which, when executed by any set of the one or more processors, perform one or more processes described herein. The process includes, in one embodiment, receiving, with an interface module of a computing system, form data related to a new and/or updated form having a plurality of data fields, gathering, with a data acquisition module of a computing system, training set data related to previously filled forms. Each previously filled form has completed data fields that each correspond to a respective data field of the new and/or updated form. The process also includes generating, with a machine learning module of a computing system, for a first selected data field of the plurality of data fields of the new and/or updated form, dependency data indicating one or more possible dependencies for an acceptable function that provides a proper data value for the first selected data field. The process also includes generating, with the machine learning module, for the first selected data field, candidate function data including a plurality of candidate functions based on the dependency data and one or more operators selected from a library of operators, generating, with the machine learning module, for each candidate function, test data by applying the candidate function to the training set data, and generating, with the machine learning module, for each candidate function, matching data by comparing the test data to the completed data fields corresponding to the first selected data field, the matching data indicating how closely the test data matches the corresponding completed data fields of the previously filled forms. The process also includes identifying, with the machine learning module, from the plurality of functions, an acceptable candidate function for the first selected data field of the new and/or updated form by determining, for each candidate function, whether or not the candidate function is an acceptable function for the first selected data field of the new and/or updated form based on the matching data, generating, with the machine learning module and after identifying the correct function for the first data field, results data indicating an acceptable function for the first data field of the new and/or updated form, and outputting, with the interface module, the results data.

Using the disclosed embodiments of a method and system for learning and incorporating new and/or updated forms in an electronic document preparation system, a method and system for learning and incorporating new and/or updated forms in an electronic document preparation system more accurately is provided. Therefore, the disclosed embodiments provide a technical solution to the long standing technical problem of efficiently learning and incorporating new and/or updated forms in an electronic document preparation system.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various parties under numerous circumstances.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “adding”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “eliminating”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “substituting”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the figures, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method for learning and incorporating forms in an electronic document preparation system, the method comprising:
receiving electronic textual data relating to a plurality of forms for which one or more functions need to be determined, the electronic textual data including at least a portion of electronic textual data including instructions to determine one or more form field values of one or more forms of the plurality of forms;
analyzing the electronic textual data to determine sentence data representing a plurality of separate sentences of the electronic textual data;
separating the electronic textual data into a data array formed of the sentence data of the determined plurality of separate sentences;
for each given sentence of sentence data representing sentences in the data array:
extracting operand data of the sentence data of the given sentence, the extracted operand data representing one or more extracted operands of the given sentence, the extracted operands representing one or more dependencies reflecting that a function to determine a data value of the given sentence depends on a data value of a different sentence of the determined plurality of separate sentences;
determining sentence fragment data for parts of speech for sentence fragments of the given sentence, a sentence fragment including sentence fragment data representing word groups forming one or more parts of speech of the given sentence, resulting in determined sentence fragment data;
separating sentence fragment data of the given sentence containing verbs and sentence fragment data containing “if” or “minus” where the associated part of speech is either a prepositional phrase or a clause introduced by a subordinating conjunction, resulting in separated sentence fragment data;
for each token present in sentence data:
processing the sentence data to remove any word present in exclusion data representing a predetermined exclusion list;
filtering the sentence data to keep only tokens meeting at least one of a plurality of token tests, resulting in filtered token data;
combine the filtered token data and the separated sentence fragment data, resulting in combined sentence fragment data:
filtering the combined sentence fragment data to eliminate sentence fragments containing words from the exclusion data representing a predetermined exclusion list, resulting in filtered sentence fragment data;
replacing, within sentences of the data array, all single-word sentence fragments of the filtered sentence fragment data having similar meanings with a single word;
extract text-readable functions from sentences of the data array by matching predetermined patterns and replacing matched patterns with function data representing text-readable functions;
converting the function data to computer readable functions; and
implementing one or more of the computer readable functions in a document preparation system.

2. The computing system implemented method for learning and incorporating forms in an electronic document preparation system of claim 1 wherein filtering the sentence data to keep only tokens meeting at least one of a plurality of token tests, resulting in filtered token data further comprises
determining a part of speech of the token;
filtering the sentence data to keep only tokens having particular predetermined parts of speech characteristics, resulting in filtered token data.

3. The computing system implemented method for learning and incorporating forms in an electronic document preparation system of claim 2 wherein filtering the sentence data to keep only tokens having particular predetermined parts of speech characteristics, resulting in filtered token data further comprises keeping a token of the sentence data if the token is a verb other than a verb having a lemma meaning “to be.”

4. The computing system implemented method for learning and incorporating forms in an electronic document preparation system of claim 2 wherein filtering the sentence data to keep only tokens having particular predetermined parts of speech characteristics, resulting in filtered token data further comprises keeping a token of the sentence data if the part of speech associated with the token is adjective superlative.

5. The computing system implemented method for learning and incorporating forms in an electronic document preparation system of claim 2 wherein filtering the sentence data to keep only tokens having particular predetermined parts of speech characteristics, resulting in filtered token data further comprises keeping a token of the sentence data if the part of speech associated with the token is adjective comparative.

6. The computing system implemented method for learning and incorporating forms in an electronic document preparation system of claim 2 wherein filtering the sentence data to keep only tokens having particular predetermined parts of speech characteristics, resulting in filtered token data further comprises keeping a token of the sentence data if the token is “divide” and the part of speech associated with the token is a noun.

7. The computing system implemented method for learning and incorporating forms in an electronic document preparation system of claim 2 wherein filtering the sentence data to keep only tokens having particular predetermined parts of speech characteristics, resulting in filtered token data further comprises keeping a token of the sentence data if the token is not found within the separated sentence fragment data.

8. The computing system implemented method for learning and incorporating forms in an electronic document preparation system of claim 1 wherein replacing, within sentences of the data array, all single-word sentence fragments of the filtered sentence fragment data having similar meanings with a single word further comprises replacing the single word sentence fragments “add,” “combine,” and “sum,” are replaced with a single word.

9. The computing system implemented method for learning and incorporating forms in an electronic document preparation system of claim 1 wherein replacing, within sentences of the data array, all single-word sentence fragments of the filtered sentence fragment data having similar meanings with a single word further comprises replacing the single word sentence fragments “add,” “combine,” and “sum,” are replaced with the word “addition.”

10. The computing system implemented method for learning and incorporating forms in an electronic document preparation system of claim 1 wherein the exclusion list includes words known to have low importance according to one or more genres of the data array.

11. The computing system implemented method for learning and incorporating forms in an electronic document preparation system of claim 1, further comprising
generating, for a first data field of at least a first sentence of the data array, dependency data indicating one or more dependencies,
wherein the dependencies include one or more of:
a data value of a second data field from a second sentence of the data array;
a data value of a first data field associated with a sentence of a form other than a form associated with the first data field; and
a constant.

12. The computing system implemented method for learning and incorporating forms in an electronic document preparation system of claim 1, wherein the sentence data of the data array is associated with a new or updated tax form.

13. A computing system implemented system for learning and incorporating forms in an electronic document preparation system comprising:
one or more computing processors;
one or more memories coupled to the one or more computing processors, the one or more memories having stored therein which when executed by the one or more computing processors perform a process for learning and incorporating forms in an electronic document preparation system comprising:
receiving electronic textual data relating to a plurality of forms for which one or more functions need to be determined, the electronic textual data including at least a portion of electronic textual data including instructions to determine one or more form field values of one or more forms of the plurality of forms;
analyzing the electronic textual data to determine sentence data representing a plurality of separate sentences of the electronic textual data;
separating the electronic textual data into a data array formed of the sentence data of the determined plurality of separate sentences;
for each given sentence of sentence data representing sentences in the data array:
extracting operand data of the sentence data of the given sentence, the extracted operand data representing one or more extracted operands of the given sentence, the extracted operands representing one or more dependencies reflecting that a function to determine a data value of the given sentence depends on a data value of a different sentence of the determined plurality of separate sentences;
determining sentence fragment data for parts of speech for sentence fragments of the given sentence, a sentence fragment including sentence fragment data representing word groups forming one or more parts of speech of the given sentence, resulting in determined sentence fragment data;
separating sentence fragment data of the given sentence containing verbs and sentence fragment data containing “if” or “minus” where the associated part of speech is either a prepositional phrase or a clause introduced by a subordinating conjunction, resulting in separated sentence fragment data;
for each token present in sentence data:
processing the sentence data to remove any word present in exclusion data representing a predetermined exclusion list;
filtering the sentence data to keep only tokens meeting at least one of a plurality of token tests, resulting in filtered token data;
combine the filtered token data and the separated sentence fragment data, resulting in combined sentence fragment data:
filtering the combined sentence fragment data to eliminate sentence fragments containing words from the exclusion data representing a predetermined exclusion list, resulting in filtered sentence fragment data;
replacing, within sentences of the data array, all single-word sentence fragments of the filtered sentence fragment data having similar meanings with a single word;
extract text-readable functions from sentences of the data array by matching predetermined patterns and replacing matched patterns with function data representing text-readable functions;
converting the function data to computer readable functions; and
implementing one or more of the computer readable functions in a document preparation system.

14. The computing system implemented method for learning and incorporating forms in an electronic document preparation system of claim 13 wherein filtering the sentence data to keep only tokens meeting at least one of a plurality of token tests, resulting in filtered token data further comprises
determining a part of speech of the token;
filtering the sentence data to keep only tokens having particular predetermined parts of speech characteristics, resulting in filtered token data.

15. The computing system implemented method for learning and incorporating forms in an electronic document preparation system of claim 14 wherein filtering the sentence data to keep only tokens having particular predetermined parts of speech characteristics, resulting in filtered token data further comprises keeping a token of the sentence data if the token is a verb other than a verb having a lemma meaning “to be.”

16. The computing system implemented method for learning and incorporating forms in an electronic document preparation system of claim 14 wherein filtering the sentence data to keep only tokens having particular predetermined parts of speech characteristics, resulting in filtered token data further comprises keeping a token of the sentence data if the part of speech associated with the token is adjective superlative.

17. The computing system implemented method for learning and incorporating forms in an electronic document preparation system of claim 14 wherein filtering the sentence data to keep only tokens having particular predetermined parts of speech characteristics, resulting in filtered token data further comprises keeping a token of the sentence data if the part of speech associated with the token is adjective comparative.

18. The computing system implemented method for learning and incorporating forms in an electronic document preparation system of claim 14 wherein filtering the sentence data to keep only tokens having particular predetermined parts of speech characteristics, resulting in filtered token data further comprises keeping a token of the sentence data if the token is “divide” and the part of speech associated with the token is a noun.

19. The computing system implemented method for learning and incorporating forms in an electronic document preparation system of claim 14 wherein filtering the sentence data to keep only tokens having particular predetermined parts of speech characteristics, resulting in filtered token data further comprises keeping a token of the sentence data if the token is not found within the separated sentence fragment data.

20. The computing system implemented method for learning and incorporating forms in an electronic document preparation system of claim 13 wherein replacing, within sentences of the data array, all single-word sentence fragments of the filtered sentence fragment data having similar meanings with a single word further comprises replacing the single word sentence fragments “add,” “combine,” and “sum,” are replaced with a single word.

21. The computing system implemented method for learning and incorporating forms in an electronic document preparation system of claim 13 wherein replacing, within sentences of the data array, all single-word sentence fragments of the filtered sentence fragment data having similar meanings with a single word further comprises replacing the single word sentence fragments “add,” “combine,” and “sum,” are replaced with the word “addition.”

22. The computing system implemented method for learning and incorporating forms in an electronic document preparation system of claim 13 wherein the exclusion list includes words known to have low importance according to one or more genres of the data array.

23. The computing system implemented method for learning and incorporating forms in an electronic document preparation system of claim 13, further comprising
generating, for a first data field of at least a first sentence of the data array, dependency data indicating one or more dependencies,
wherein the dependencies include one or more of:
a data value of a second data field from a second sentence of the data array;
a data value of a first data field associated with a sentence of a form other than a form associated with the first data field; and
a constant.

24. The computing system implemented method for learning and incorporating forms in an electronic document preparation system of claim 13, wherein the sentence data of the data array is associated with a new or updated tax form.
